(19) United States
(12) Patent Application Publication
(10) Pub. No.: US 2026/0342397 A1
(43) Pub. Date: Oct. 29, 2026

(54) METHOD FOR UPLINK SOUNDING REFERENCE SIGNAL PRECODER SELECTION FOR INTERFERENCE SUPPRESSION

(71) Applicant: Google LLC, Mountain View, CA (US)

(72) Inventors: Yushu Zhang, Beijing (CN); Chih-Hsiang Wu, Taipei (TW)

(21) Appl. No.: 19/116,248

(22) PCT Filed: Sep. 30, 2022
(86) PCT No.: PCT/CN2022/123591

§ 371 Date: Mar. 27, 2025

(51) Int. Cl. H04B 7/06

(52) U.S. Cl. CPC H04B 7/0626; H04B 7/0639

(57) ABSTRACT

This disclosure provides methods for selecting a precoder for uplink sounding reference signal (SRS), useful in multi-transmission and reception point (multi-TRP) cases. A user equipment (UE) device receives (450), from at least a first network entity, a first channel state information reference signal (CSI-RS), and also receives (455), from a second network entity, a second CSI-RS. The UE device then receives (430), from the first network entity, for example, control signaling indicating at least one SRS resource set associated with the first CSI-RS or the second CSI-RS. The UE device transmits (470) precoded SRS resources based on the received SRS resource set and a precoder computed based on the first CSI-RS and the second CSI-RS. In some cases, the UE device determines (460) the precoder based on the first CSI-RS and the second CSI-RS such that the precoded SRS resources suppress interference with signals received at a third network entity.

### TECHNICAL FIELD

The present disclosure relates generally to uplink transmission schemes.

### BACKGROUND

The Third Generation Partnership Project (3GPP) is currently in the process of specifying a new Radio Interface called 5G New Radio (5G NR) as well as a Next Generation Packet Core Network (NG-CN or NGC). The 5G NR architecture will have three components: a 5G Radio Access Network (5G-RAN), a 5G Core Network (5GC), and a User Equipment (UE). In order to facilitate the enablement of different data services and requirements, the 3GPP 5G NR cellular network supports network slicing, which enables the multiplexing of virtualized and independent logical networks on the same physical network infrastructure.

NR supports uplink (e.g., physical uplink shared channel, PUSCH) multi-antenna precoding (e.g., in multiple layers). For massive input massive output (MIMO) scenarios, a UE device precodes signals after layer mapping using a precoding matrix. Generally, the UE device determines the precoding matrix using codebook based methods or non-codebook (NCB) based methods. In codebook based methods, a base station (BS) provides the UE device instructions on PDCCH regarding a choice of the precoding matrix selected from a standard codebook. The BS selects the precoding matrix based on sounding reference signals (SRS) from antenna ports of the UE device.

Unlike codebook based methods, NCB based uplink transmission does not rely on codebook selection. In an NCB scheme, a BS first transmits channel state information (CSI) reference signals (CSI-RS) to a UE device. The UE device measures the CSI-RS and calculates a precoder for SRS transmissions to the BS. Using precoding weights derived from the calculated precoder, the UE device transmits precoder beams on the SRS resources to the BS. The BS receives the precoder beams and uses the set of SRS resources to determine a number of layers for physical uplink shared channel (PUSCH) transmissions. The BS also selects a subset of the precoded SRS resources to generate the number of layers. The BS then signals to the UE device, via downlink control information (DCI), allocations of PUSCH resources in the UE device. The UE device uses the allocated resources to transmit PUSCH signals and demodulated reference signals (DMRS) according to the BS selected number of layers and precoding weights.

Multi-TRP complicates the above precoder selection or determination in NCB uplink transmissions. Multi-TRP enhances massive multiple input multiple output (MIMO) and enables a BS (e.g., a gNB) to communicate with a UE device using multiple TRPs (e.g., each TRP may be considered as a set of antennas, or another BS). The multiple TRPs may be transparent to each other and may operate jointly (e.g., the UE device sees them the same and the communication is not interrupted until all related TRPs fail). Conventionally, when a UE device is to determine the uplink precoder for uplink NCB transmission, the UE device relies only on the downlink channel from one TRP: one CSI-RS from one TRP—and such determination would be insufficient in multi-TRP scenarios, where the UE device receives two or more CSI-RS from two or more TRPs (target TRPs).

### SUMMARY

The present disclosure provides methods, systems, and techniques for selecting a precoder for uplink sounding reference signal (SRS), useful in multi-transmission and reception point (multi-TRP) use cases. A user equipment (UE) device, when performing uplink transmission in a non-codebook (NCB) based scheme, sends the precoded SRS to two or more target receiving TRPs. The precoded SRS strengthens the signal reception power in the two or more target receiving TRPs (referred to as target TRPs). The precoded SRS may also suppress interference to signals in non-target TRPs (referred to as victim TRPs) that are not intended receivers of the precoded SRS, resulting in performance improvement at the victim TRPs.

When a UE device is to determine the uplink precoder for uplink NCB transmission, the UE device, conventionally, relies only on the downlink channel from one TRP: one CSI-RS from one TRP—and such determination would be insufficient in multi-TRP scenarios, where the UE device receives two or more CSI-RS from two or more TRPs (target TRPs). For example, the UE device would not know how to select a precoder to produce good precoded channel energy in all of the two or more target TRPs. Further, in multi-TRP operations, an uplink signal (such as the SRS) from the UE device might generate a strong interference to some neighbor TRPs (the victim TRPs) because the pathloss between the UE device and the victim TRPs could be smaller than the pathloss between the UE device and the target TRPs. In the existing NCB based transmission operations, the UE device does not consider interference level at the victim TRPs when determining an SRS precoder. Then, using the conventional determination, the UE device may select a precoder that generates substantial interference to the victim TRPs. Aspects of the present disclosure allow the UE device to select a precoder regarding two or more target TRPs and at least one victim TRP in multi-TRP scenarios.

3GPP defines different types of SRS, including SRS for antenna switching (AS) used for downlink CSI measurement based on uplink and downlink channel reciprocity. For example, the UE device transmits a set of SRS signals for AS using different antenna port(s). When the BS (e.g., a gNB) receives the SRS signals, the BS estimates the uplink channel and derives, using the principle of reciprocity, the downlink channel estimates and determines a precoder for downlink transmission. Existing SRS for AS is based on non-precoded operations, meaning that the UE device transmits the SRS for AS without a precoder. The non-precoded SRS may generate interference to the victim TRPs. According to aspects of this disclosure, a UE device uses precoded SRS for AS (instead of non-precoded SRS for AS) to increase the link budget toward target TRPs and reduce the interference at victim TRPs. The present disclosure provides a mechanism to maintain the understanding between the BS and the UE device on the precoder used for SRS for AS.

For example, a UE device receives, from at least a first network entity (e.g., a first target TRP), a first CSI-RS. The UE device also receives, from a second network entity (e.g., a second target TRP), a second CSI-RS. The UE device receives, from either the first network entity or the second network entity, control signaling indicating at least one SRS resource set associated with the first CSI-RS or the second CSI-RS. The UE device transmits one or more precoded SRS resources (e.g., NCB type SRS or AS type SRS) based on the received SRS resource set and a precoder computed based on the first CSI-RS and the second CSI-RS. In some cases, the UE device determines the precoder based on the first CSI-RS and the second CSI-RS such that the precoded SRS resources suppress interference with signals received at a third network entity (e.g., a victim TRP). Details of the methods (as well as related systems and techniques) are discussed in detail below.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a diagram of a wireless communications system including a plurality of network entities in communication over a plurality of cells, according to some embodiments;

FIG. 2 illustrates an example of wireless communications using multiple transmission and reception points (multi-TRPs), according to some embodiments;

FIG. 3 illustrates an example of wireless communications using multiple transmission and reception points (multi-TRPs) when interference occurs, according to some embodiments;

FIG. 4 illustrates an example signaling diagram for precoder determination in an uplink transmission scheme, according to some embodiments;

FIG. 5A is a flow diagram depicting a method for precoder determination by a user equipment (UE) device in multi-TRP applications, according to some embodiments;

FIG. 5B is a flow diagram depicting a method for precoder determination by a UE device for interference suppression in multi-TRP applications, according to some embodiments;

FIG. 6A is a flow diagram depicting a method for precoder determination by a network entity in multi-TRP applications, according to some embodiments;

FIG. 6B is a flow diagram depicting a method for precoder determination by a network entity for interference suppression in multi-TRP applications, according to some embodiments;

FIG. 7A illustrates an example signaling diagram for precoder determination in a non-codebook (NCB) semi-persistent uplink scheme with multi-TRPs, according to some embodiments;

FIG. 7B illustrates another example signaling diagram for precoder determination in a semi-persistent uplink scheme with multi-TRPs, according to some embodiments;

FIG. 8A illustrates an example signaling diagram for precoder determination in an aperiodic uplink scheme with multi-TRPs, according to some embodiments;

FIG. 8B illustrates another example signaling diagram for precoder determination in an aperiodic uplink scheme with multi-TRPs, according to some embodiments;

FIG. 9 illustrates an example signaling diagram for precoder determination and for transmitting an uplink precoder report with associated CSI-RS, according to some embodiments;

FIG. 10 is a flow diagram depicting a method for precoder determination and for transmitting an uplink precoder report with associated CSI-RS by a UE device, according to some embodiments;

FIG. 11 is a flow diagram depicting a method for precoder determination and for receiving an uplink precoder report with associated CSI-RS by a network entity, according to some embodiments;

FIG. 12 is a flow diagram depicting a method of precoder determination by a UE device in multi-TRP applications, according to some embodiments; and

FIG. 13 is a flow diagram depicting a method of precoder determination by a network entity in multi-TRP applications, according to some embodiments.

### DETAILED DESCRIPTION

For ease of illustration, the following techniques are described in an example context in which one or more UE devices and RANs implement one or more radio access technologies (RATs) including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, the present disclosure is not limited to networks employing a 5G NR RAT configuration, but rather the techniques described herein can be applied to any combination of different RATs employed at the UE devices and the RANs. Also, the present disclosure is not limited to the examples and context described herein, but rather the techniques described herein can be applied to any network environment.

At a high level, this disclosure provides methods and techniques for uplink precoder selection for multi-TRP applications, including interference suppression. For example, the techniques herein address uplink precoder determination, calculation, or selection with regard to two or more target TRPs. The uplink precoder also considers interference suppression in victim TRPs. In the uplink transmission scheme, the present disclosure further provides a mechanism to maintain a common understanding between the network entity (e.g., a gNB) and the UE device on the precoder for SRS for antenna switching (AS). Therefore, this disclosure achieves several technical advantages over existing uplink schemes. First, a UE device deriving the uplink precoder based on more than one CSI-RS from two or more TRPs can improve the uplink performance for the UE with more than one target receiving TRP. Second, the uplink precoder can use interference suppression methods to improve the neighbor cell(s) or victim TRP(s) performance.

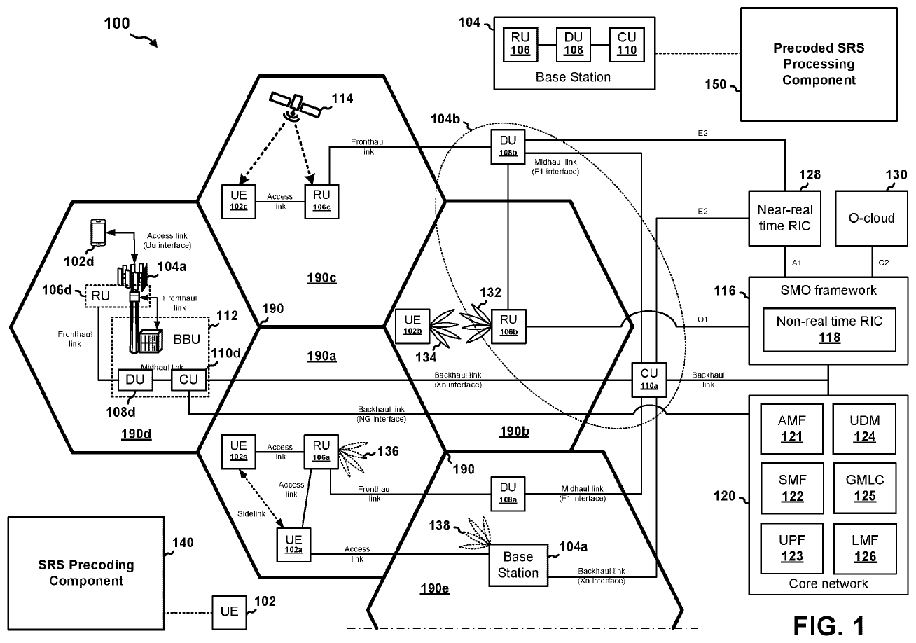

FIG. 1 illustrates a diagram 100 of a wireless communications system associated with a plurality of cells 190. The wireless communications system includes user equipments (UEs) 102 and base stations 104, where some base stations 104a include an aggregated base station architecture and other base stations 104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links based on F1 interfaces. The DUs 108a-108b may respectively communicate with the RU 106a and the RUs 106b-106c via respective fronthaul links. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104a of the cell 190e simultaneously serve.

One or more CUs 110, such as the CU 110a or the CU 110d, may communicate directly with a core network 120 via a backhaul link. For example, the CU 110d communicates with the core network 120 over a backhaul link based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link based on an Xn interface. For example, the CU 110d of the base station 104a communicates with the CU 110a of the base station 104b over the backhaul link based on the Xn interface. Similarly, the base station 104a of the cell 190e may communicate with the CU 110a of the base station 104b over a backhaul link based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link between the RU 106d and the baseband unit (BBU) 112 of the cell 190d or, more specifically, the fronthaul link between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104a of the cell 190e via cross-cell communication beams of the RU 106a and the base station 104a.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134 of the UE 102b, which may correspond to inter-cell communication beams or cross-cell communication beams. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Hence, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104a of cell 190d to transmit a downlink/forward link communication to the UE 102d or receive an uplink/reverse link communication from the UE 102d based on the Uu interface associated with the access link between the UE 102d and the base station 104a/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHz, FR4, which ranges from 71 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134 from the RU 106b in one or more receive directions of the UE 102b. In a further example, the UE 102b may also transmit an uplink beamformed signal to the RU 106b based on the second set of beams 134 in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104a and a second base station 104b. For instance, the RU 106a of cell 190a may transmit a beamformed signal based on an RU beam set 136 to the base station 104a of cell 190e in one or more transmit directions of the RU 106a. The base station 104a of the cell 190e may receive the beamformed signal from the RU 106a based on a base station beam set 138 in one or more receive directions of the base station 104a. Similarly, the base station 104a of the cell 190e may transmit a beamformed signal to the RU 106a based on the base station beam set 138 in one or more transmit directions of the base station 104a. The RU 106a may receive the beamformed signal from the base station 104a of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmit reception point (TRP), a network node, a network entity, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

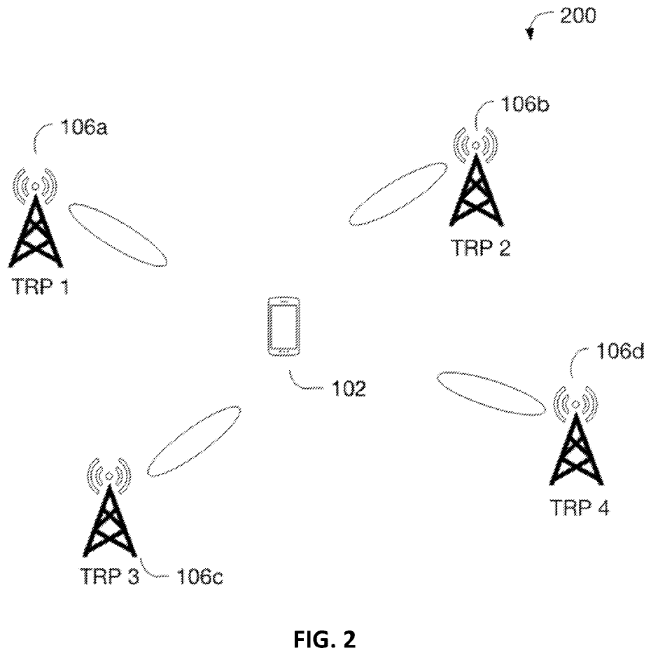

Still referring to FIG. 1, in certain aspects, the UE 102 may include a sounding reference signal (SRS) precoding component 140 configured to transmit one or more precoded SRS resource in the at least one SRS resource set indicated by control signaling from the base station 104 using a precoder computed based on two or more CSI-RS from two or more corresponding target TRPs. As further discussed in FIG. 2 below, the UE 102 may use the SRS precoding component 140 to determine the precoder for transmitting the one or more precoded SRS resources based on the two or more CSI-RSs and at least one other CSI-RS from a victim TRP such that the precoded SRS resources suppress interference to signals received at the third network entity.

In some cases, the SRS precoding component 140 may include one or more radio frequency (RF) modems, a processor, and at least one non-transitory memory storing executable instructions to cause the processor and/or the one or more RF modems to preform one or more functions or operations disclosed herein (details below). For example, the SRS precoding component 140 is configured to receive one or more CSI-RSs from a network entity and transmit one or more CSI reports to the network entity.

In certain aspects, the base station 104 or a network entity of the base station 104 may include a precoded SRS processing component 150 configured to transmit to the UE device 102 control signaling indicating at least one SRS resource set. The precoded SRS processing component 150 then transmits a CSI-RS associated with the at least one SRS resource set. The precoded SRS processing component 150 receives one or more precoded SRS resources in the at least one SRS resource set.

In some cases, the precoded SRS processing component 150 on the network side may include one or more RF modems, a processor, and at least one non-transitory memory storing executable instructions to cause the processor and/or the one or more RF modems to preform one or more functions or operations disclosed herein. For example, the precoded SRS processing component 150 is configured to receive the one or more precoded SRS resources that are precoded based on the CIS-RS transmitted by the network entity and at least a second CSI-RS transmitted by a second network entity (e.g., another target TRP associated with the base station 104).

FIG. 2 illustrates an example 200 of wireless communications using multi-TRPs 106a-106d, according to some embodiments. In such a multi-TRP scenario, the UE device 102 may communicate with more than one TRPs simultaneously to make use of the through-put and reliability. The example multi-TRPs 106a-106d, though labeled as “106,” may be different from the example RU 106 of FIG. 1, depending on specific deployment and/or network configurations as understood in 5G NR multi-TRP scenarios. Although the multi-TRPs 106a-106d are available, the pathloss between the UE device 102 and each of the TRPs 106s is different. During operation, the UE may need to transmit some uplink signals to each TRP. In one example, for downlink coherent joint transmission based multi-TRP operation, the base station 104 (e.g., a gNB) triggers the UE to transmit sounding reference signals (SRS) for antenna switching (AS) to each TRP for downlink channel state information (CSI) measurement based on uplink/downlink channel reciprocity. In another example, the base station 104 may trigger the UE device 102 to transmit physical uplink share channel (PUSCH) or physical uplink control channel (PUCCH) to one or more than one TRPs. The UE may transmit the PUSCH or PUCCH based on a single beam or different beams, such as when the UE enables the analog beamforming. Then the one or more than one TRPs can perform independent or joint decoding for the PUSCH/PUCCH. This operation can improve the reliability for the uplink transmission.

The 3GPP standard includes different usages for the SRS, including SRS for codebook (CB) based transmission (SRS for CB), SRS for non-codebook (NCB) based transmission (SRS for NCB), SRS for beam management (BM) and SRS for antenna switching (AS). The gNB can configure the usage of an SRS resource set by RRC parameter usage. Aspects of the present disclosure pertain to NCB and AS types in examples herein, while the precoder determination for interference suppression is not limited by specific SRS types.

The SRS for CB is used for uplink channel state information (CSI) measurement for uplink CB-based transmission. The UE transmits the SRS for CB from one or more than one antenna ports. The gNB measures the uplink channel based on the SRS for CB and selects a precoder from a pre-defined codebook. Usually, the selected precoder could be the one that can produce the strongest precoded channel energy based on the estimated channel. Then the gNB can indicate the precoder to UE by the downlink control information (DCI) field precoding information and number of layers, where a transmit precoder matrix indicator (TPMI) and transmit rank indicator (TRI) are indicated. Then the UE can identify the precoder for PUSCH transmission based on the pre-defined precoder indicated by the TPMI and TRI.

The SRS for NCB is used for uplink CSI measurement for uplink NCB-based transmission. For an SRS resource set for NCB, the gNB can configure an associated CSI reference signal (CSI-RS) by RRC signaling. The UE can estimate a downlink channel based on the associated CSI-RS and use the estimated downlink channel to derive the uplink precoder for the SRS with the assumption of uplink and downlink channel reciprocity. In one example, the uplink precoder can be calculated based on the eigen vector of the average estimated channel as follows:

$${USV}^{H} = \frac{1}{N} {\sum }_{j = 1}^{N} {H}_{j} {H}_{j}^{H}$$

Where the matrix V is the calculated precoder; Hⱼ is the estimated channel at subcarrier j based on the associated CSI-RS with the dimension of N_{Rx} by N_{Tx}, where N_{Rx} is the number of receiving antenna ports and N_{Tx} is the number of antenna ports for the associated CSI-RS; N is the total number of subcarriers for the associated CSI-RS.

Then the UE can apply a rank one precoder, e.g., a column of matrix V, for an SRS resource for NCB. Thus, each SRS resource for NCB is transmitted from one port with a rank 1 precoder. After measurement of the SRS resources in a resource set for NCB, the gNB can indicate K SRS resource indicators (SRIs) for uplink NCB transmission for a rank K transmission, where K is an integer above 0. The UE should transmit the PUSCH based on the precoder(s) applied to the most recent transmission of the indicated K SRS resources.

The SRS for BM is used for uplink beam measurement and selection. The UE can apply different beams to different SRS resources for BM. The gNB performs measurement on the SRS resources. Then based on the measurement of the SRS resources for BM, the gNB can perform the uplink beam selection by indicating an SRI for an uplink channel, e.g., PUSCH, PUCCH or another SRS, to the UE. The UE transmits the corresponding uplink channel based on the same beam as that is applied to the SRS indicated by the SRI.

The SRS for AS is used for downlink CSI measurement based on uplink and downlink channel reciprocity. The UE can transmit a set of SRS resources for AS with different antenna port(s). Then by receiving the SRS resources, the gNB can estimate the uplink channel so as to derive the downlink channel and determine the precoder for downlink transmission. In one example, for a UE with X, e.g., X=2, transmission antenna ports and Y, e.g., Y=4, receiving antenna ports (xTyR), the gNB can configure an SRS resource set with ceil(y/x), e.g., 2, SRS resources, where each SRS resources are transmitted from X antenna ports.

The UE transmits the SRS resource(s) in a periodic SRS resource set based on the periodicity and offset configured by RRC parameter periodicityAndOffset-p. The UE transmits the SRS resource(s) in a semi-persistent SRS resource set after receiving the activation signaling by a MAC control element (CE) based on the periodicity and offset configured by RRC parameter periodicityAndOffset-sp. The UE transmits the SRS resource(s) in an aperiodic SRS resource set after receiving the DCI to trigger the SRS resource set in the slot with a slot offset configured by RRC parameter slotOffset from the slot with the last symbol of the DCI or a reference slot indicated by the DCI. The triggered SRS resource set index is indicated by DCI field SRS request. The DCI can also be used to trigger PDSCH/PUCCH or PUSCH.

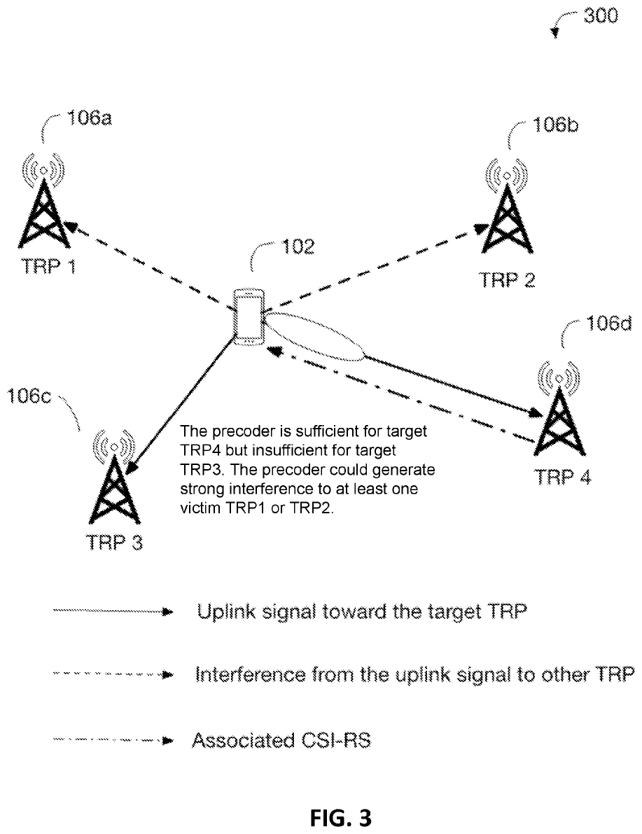

FIG. 3 illustrates an example 300 of wireless communications using multiple transmission and reception points (multi-TRPs) when interference occurs, according to some embodiments. As shown, the UE device 102 intends to provide uplink transmissions to target TRPs 3 and 4, as indicated by the solid lines. The UE device 102, based on conventional precoder determination that uses CSI-RS from only TRP 4, selects the precoder that is sufficient for the target TRP 4 but insufficient for the target TRP 3. Furthermore, as mentioned above, because of the pathloss differences, the precoder may result in signals that generate strong interferences to the victim TRPs 1 and 2 (as indicated by the dashed lines). For example, the UE device 102 does not consider the signals being received at the victim TRPs 1 and 2 and selects a precoder that results in the interference.

Conventionally, when determining the uplink precoder for uplink NCB transmission, the UE device 102 may rely only on the downlink channel from one TRP, such as one CSI-RS from one TRP. Then when the number of target TRPs is more than one, the UE faces difficulties in selecting a precoder to produce good precoded channel energy. Further, in multi-TRP operations, an uplink signal may generate strong interference to some neighbor TRPs as the pathloss between the UE and the TRPs could be smaller. With the current NCB based transmission operation, the precoder selection does not take the interference level into account. Then it is possible that the selected precoder could generate more interference to neighbor TRPs. Thus, as shown in FIG. 3, how to select the uplink precoder for uplink NCB based transmission with regard to more than one target receiving TRPs and with regard to interference suppression for some neighbor TRPs could be one problem.

In addition, conventional SRS for antenna switching (AS) is based on non-precoded operation. Thus, the UE transmits the SRS for AS without precoder in conventional schemes. Compared to precoded SRS, even though the link budget for the non-precoded SRS could be smaller, the non-precoded SRS may generate more interference to the neighbor TRPs than precoded SRS. According to aspects of the present disclosure, a UE device uses precoded SRS for AS to increase the link budget and reduce the interference. The techniques herein address, for precoded SRS for AS, how to derive, calculate, determine, or select the precoder for the AS type SRS. Accordingly, the gNB also needs to know the uplink precoder so as to recover the downlink channel as follows.

$${H}_{j}^{( DL )} = {\tilde{H}}_{j} {W}^{H}$$

### Where

$${H}_{j}^{( DL )}$$

indicates the estimated downlink channel at subcarrier j; \tilde{H}ⱼ is the estimated channel from the SRS for AS at subcarrier j; W is the precoder applied for the SRS for AS.

Aspects of the present disclosure also address how to maintain the same understanding between gNB and UE on the selected precoder for SRS for AS (e.g., precoder reports).

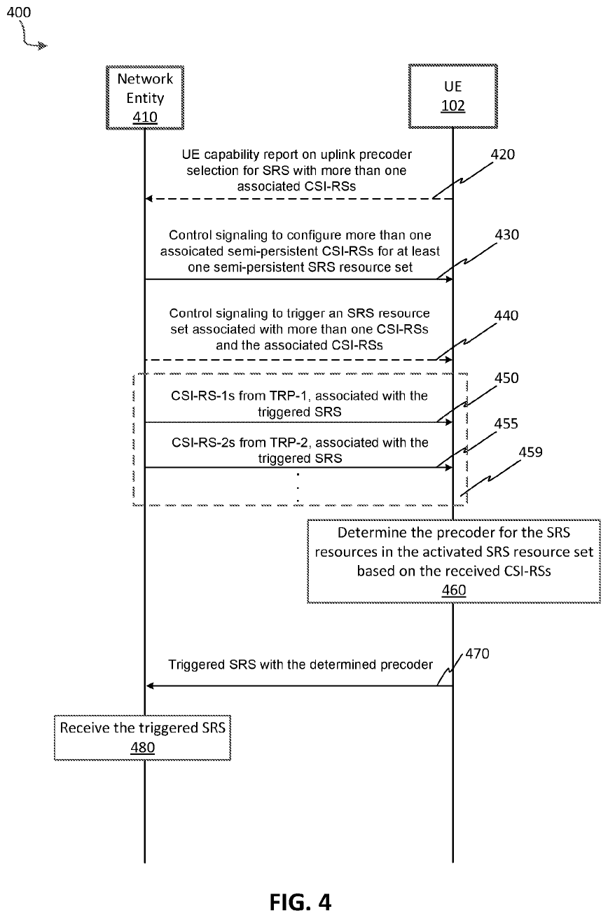

FIG. 4 illustrates an example signaling diagram for precoder determination in an uplink transmission scheme, according to some embodiments. The signaling diagram 400 illustrates a procedure for uplink precoder selection with regard to two or more target receiving TRPs and interference suppression. As shown, the UE device 102 may transmit 420 a UE capability report regarding uplink precoder selection for SRS with more than one associated CSI-RSs (e.g., in multi-TRP use cases). The network entity 410 (e.g., a TRP thereof, such as a first target TRP), upon receiving the UE capability report, transmits 430 control signaling to configure more than one semi-persistent CSI-RS for at least one semi-persistent SRS resource set in the UE device 102.

In some cases, the network entity 410 transmits 440 control signaling to trigger an SRS resource set associated with more than one CSI-RS and the associated CSI-RSs. The network entity 410 then transmits 450, through a first TRP, multiple CSI-RS-1s associated with the triggered SRS. The network entity 410 also transmits 455, through a second TRP, multiple CSI-RS-2s associated with the triggered SRS. Although FIG. 4 illustrates the network entity 410 transmits the CSI-RS-1s and CSI-RS-2s separately, the network entity 410 may transmit the CSI-RSs jointly, simultaneously, or concurrently. In some cases, the network entity 410 may include multiple TRPs for transmitting (450 and 455, 459) the CSI-RSs, or another network entity (not shown) or TRP may transmit 455 the CSI-RS-2s, when the other network entity and the network entity 410 are transparent to each other. The UE device 102, upon measuring the CSI-RSs from the network entity 410 (or network entities), determines 460 the precoder for the SRS resources in the activated SRS resource set based on the received CSI-RSs. The UE device 102 then transmits 470 triggered SRS with the determined precoder to the network entity 410. The network entity 410 receives 480 the triggered SRS.

In some embodiments, the UE reports one or more capabilities for uplink precoder selection with interference suppression to the network entity 410. For example, the one or more capabilities indicate the maximum number of associated CSI-RS resources for signal reception for uplink precoder selection and the maximum number of associated CSI-RS resources for interference suppression for uplink precoder selection. In other implementations, the network entity 410 receives the one or more capabilities from a core network (e.g., Access and Mobility Management Function (AMF)).

In some embodiments, the network entity 410 receives from another base station (e.g., gNB or eNB) the one or more UE capabilities regarding uplink precoder selection for SRS. Based on the one or more UE capabilities, the network entity 410 may configure at least one SRS resource set with two or more associated CSI-RS resources. In some embodiments, the network entity 410 transmits to the UE an RRC message (e.g., RRCReconfiguration message) including the associated CSI-RS related information. Then, for semi-persistent SRS, the network entity 410 may transmit to the UE a MAC CE to trigger the transmission; for aperiodic SRS, the network entity 410 may transmit to the UE a DCI to trigger the transmission. The network entity 410 may activate or trigger the associated CSI-RSs based on a separate MAC CE or DCI or the same MAC CE or DCI used to trigger the semi-persistent SRS or aperiodic SRS transmission. The network entity 410 transmits the associated CSI-RSs for the UE to derive the uplink precoder for SRS. Based on the received CSI-RSs, the UE may estimate the channel(s) for the target receiving TRP(s) and/or the channel(s) for the victim TRP(s) to determine an uplink precoder for signal reception and interference suppression. Then UE can transmit 470 the triggered SRS based on the determined uplink precoder.

Details for each step are provided in the embodiments below. The UE may apply the selected precoder for uplink signal transmission. The precoder selection for signal reception is to identify an uplink precoder to strengthen the signal reception power at the target receiving TRPs from the uplink signal with the selected precoder. The precoder selection for interference suppression is to identify an uplink precoder to reduce the interference to neighbor/victim TRP(s) from the uplink signal with the selected precoder.

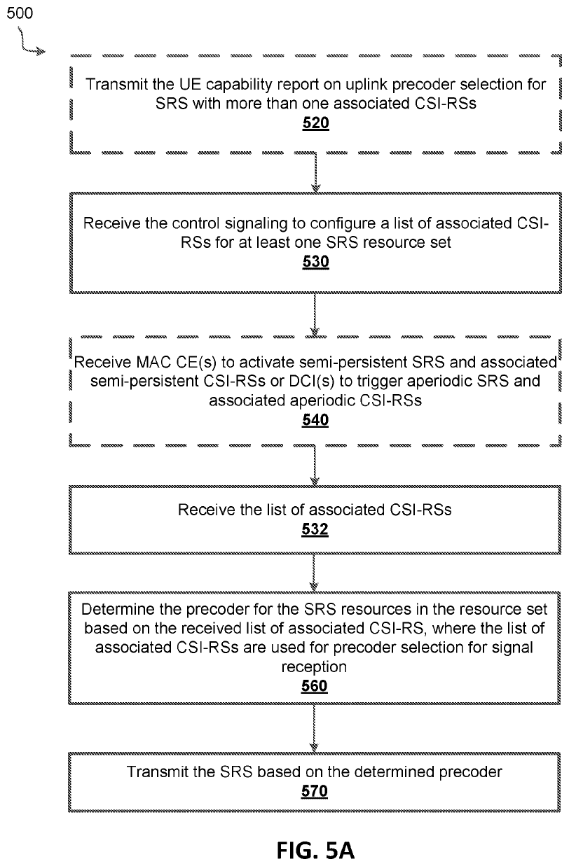

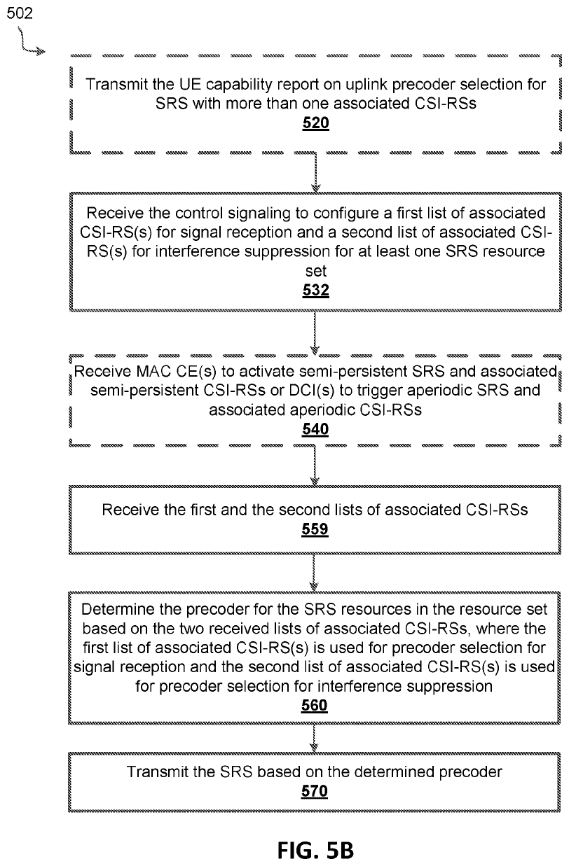

FIG. 5A is a flow diagram depicting a method for precoder determination by a user equipment (UE) device in multi-TRP applications, according to some embodiments. The method 500 illustrates example behaviors of the UE device 102 for selecting an uplink precoder for SRS with a list of associated CSI-RSs. The UE device may use the list of associated CSI-RSs to select an uplink precoder for uplink signal reception. As shown, a UE device (optionally) transmits 520 the UE capability report on uplink precoder selection for SRS with more than one associated CSI-RSs. The UE device receives 530 the control signaling to configure a list of associated CSI-RSs for at least one SRS resource set. The UE device may receive 540 media access control (MAC) control elements (CEs) to activate semi-persistent CSI-RSs or may receive 540 downlink control information (DCI(s)) to trigger aperiodic SRS and associated aperiodic CSI-RSs.

The UE device receives 532 the list of associated CSI-RSs (for the at least one resource set). Based on the received list of CSI-RSs, the UE device determines 560 the precoder for the SRS resources in the resource set based on the received list of associated CSI-RS. The list of associated CSI-RSs is used for precoder selection for signal reception. The UE device then transmits 570 the SRS based on the determined precoder.

FIG. 5B is a flow diagram depicting a method for precoder determination by a UE device for interference suppression in multi-TRP applications, according to some embodiments. As shown, the method 502 illustrates the UE behavior for selecting an uplink precoder for SRS using two lists of associated CSI-RSs. The first list of associated CSI-RS(s) is used by the UE to select an uplink precoder for uplink signal reception and the second list of associated CSI-RS(s) is used for precoder selection for uplink interference suppression. Compared to FIG. 5A, operations 520, 540, and 570 are common. On the other hand, the UE device receives 532 the control signaling to configure a first list of associated CSI-RS(s) for signal reception, and a second list of associated CSI-RS(s) for interference suppression for at least one SRS resource set. The UE device receives 559 the first and the second lists of associated CSI-RSs and determines 560 the precoder for the SRS resources in the resource set based on the two received lists of associated CSI-RSs. The first list of associated CSI-RS(s) is used for precoder selection for signal reception. The second list of associated CSI-RS(s) is used for precoder selection for interference suppression.

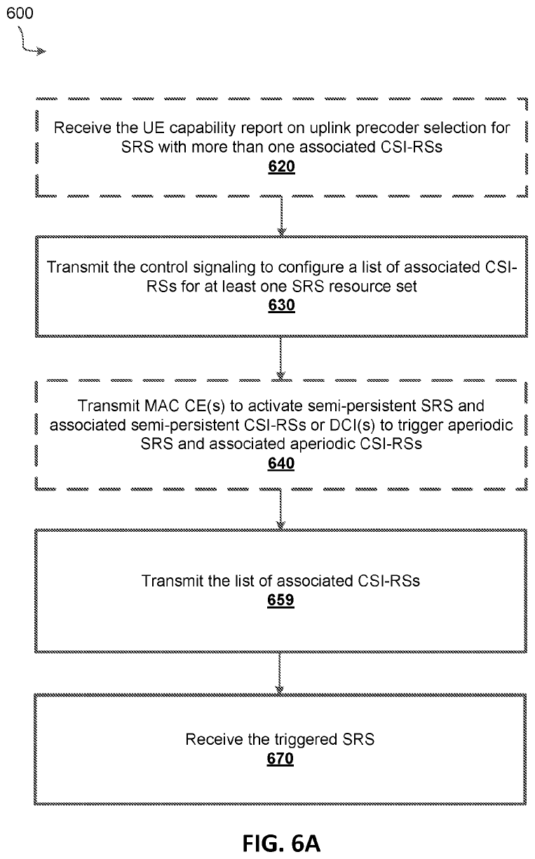

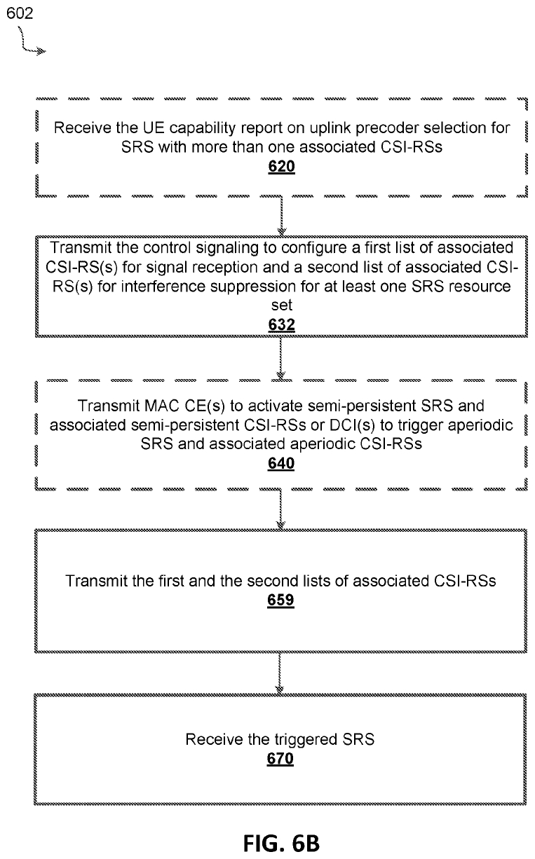

FIG. 6A is a flow diagram depicting a method for precoder determination by a network entity in multi-TRP applications, according to some embodiments. The method 600 by the network entity may correspond to the method 500 by the UE device. That is, the method 600 illustrates the gNB behavior for selecting an uplink precoder for SRS using one list of associated CSI-RSs. As shown, the network entity receives 620 the UE capability report on uplink precoder selection for SRS with more than one associated CSI-RSs. The network entity transmits 630 the control signaling to configure a list of associated CSI-RSs for at least one SRS resource set. The network entity transmits 640 MAC CE(s) to activate semi-persistent SRS and associated semi-persistent CSI-RSs; or the network entity transmits 640 DCI(s) to trigger aperiodic SRS and associated aperiodic CSI-RSs. The network entity then transmits 659 the list of associated CSI-RSs to the UE device. The network entity receives 670 the triggered SRS precoded by the UE device.

FIG. 6B is a flow diagram depicting a method for precoder determination by a network entity for interference suppression in multi-TRP applications, according to some embodiments. The method 602 by the network entity may correspond to the method 502 by the UE device. That is, the method 602 illustrates the gNB behavior for selecting an uplink precoder for SRS using two lists of associated CSI-RSs (one for interference suppression): the first list of associated CSI-RS(s) is used by the UE to select an uplink precoder for uplink signal reception and the second list of associated CSI-RS(s) is used by the UE to select an uplink precoder for uplink interference suppression. Compared to FIG. 6A, operations 620, 640, and 670 are common. On the other hand, the network entity transmits 632 the control signaling to configure a first list of associated CSI-RS(s) for signal reception and a second list of associated CSI-RS(s) for interference suppression for at least one SRS resource set. The network entity also transmits 659 the first and the second lists of associated CSI-RSs (e.g., via different TRPs, such as a target TRP and a victim TRP) to the UE device.

In various aspects of the present disclosure, unless stated otherwise, an RRC signaling may include/indicate an RRC reconfiguration message from gNB to UE, or a system information block (SIB). The SIB can be an existing SIB (e.g., SIB1) or a new SIB (e.g., SIB J, where J is an integer above 21) transmitted by gNB.

In some embodiments, the UE reports to the network entity 410 a capability indicating that the UE is capable of uplink precoder selection for two or more target receiving TRPs and/or interference suppression. The UE capability may include at least one of the following elements: the maximum number of associated CSI-RS resources for signal reception for an SRS resource set for NCB, the maximum number of associated CSI-RS resources for interference suppression for an SRS resource set for NCB; whether the UE supports associated CSI-RS resource for an SRS resource set for AS; or the maximum number of associated CSI-RS resources for signal reception for an SRS resource set for AS; the maximum number of associated CSI-RS resources for interference suppression for an SRS resource set for AS. The maximum number of associated CSI-RS resources in the UE capability above may be counted/determined based on the maximum number of configured associated CSI-RS resources and/or maximum number of associated CSI-RS resources in a slot. The UE capability may be reported per feature set, per band, per band combination and/or per UE.

In some embodiments, the network entity 410 may transmit a control signaling on associated CSI-RS resources for an SRS resource set for NCB/AS by higher layer signaling, e.g., RRC signaling. In some embodiments, with regard to two or more target receiving TRPs, the network entity 410 may configure an additional associated CSI-RS resource or a list of associated CSI-RS resources for signal reception for SRS for NCB/AS by RRC signaling. In an example, the network entity 410 can configure the associated CSI-RS resources by following RRC parameter channelMeasAssociatedCSI-RSList as shown in the example ASN. 1 code 1 below.

Example ASN.1 code 1

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) |
| | OF SRS-ResourceId |

OPTIONAL, -- Cond Setup

| resourceType | CHOICE { | |
|---|---|---|
| aperiodic | SEQUENCE { | |
| aperiodicSRS-ResourceTrigger | INTEGER | |
| | (1..maxNrofSRS-TriggerStates-1), | |
| csi-RS | NZP-CSI-RS-ResourceId | OPTIONAL, -- |
| | | Cond NonCodebook |
| slotOffset | INTEGER (1..32) | OPTIONAL, -- Need S |

```
      ...,
      [[
```

| | |
|---|---|
| aperiodicSRS-ResourceTriggerList | SEQUENCE (SIZE(1..maxNrofSRS- |
| | TriggerStates-2)) OF |
| INTEGER (1..maxNrofSRS-TriggerStates-1) | OPTIONAL -- Need M |

```
      ]],
        [[
```

| | |
|---|---|
| channelMeasAssociatedCSI-RSList | SEQUENCE (SIZE(1..maxNrofSRS-- |
| SignalReception)) OF NZP-CSI-RS-ResourceId | OPTIONAL, -- Cond NonCodebook or |

```
antenna switching
        ]]
    },
```

| semi-persistent | SEQUENCE { | |
|---|---|---|
| associatedCSI-RS | NZP-CSI-RS-ResourceId | OPTIONAL, -- Cond |

```
NonCodebook
      ...,
        [[
```

| | |
|---|---|
| channelMeasAssociatedCSI-RSList | SEQUENCE (SIZE(1.. maxNrofSRS- |
| SignalReception)) OF NZP-CSI-RS-ResourceId | OPTIONAL, -- Cond NonCodebook or |

```
antenna switching
        ]]
    },
```

| periodic | SEQUENCE { | |
|---|---|---|
| associatedCSI-RS | NZP-CSI-RS-ResourceId | OPTIONAL, -- Cond |

```
NonCodebook
      ...,
        [[
```

| | |
|---|---|
| channelMeasAssociatedCSI-RSList | SEQUENCE (SIZE(1.. maxNrofSRS- |
| SignalReception)) OF NZP-CSI-RS-ResourceId | OPTIONAL, -- Cond NonCodebook or |

```
antenna switching
        ]]
    }
  },
```

| usage | ENUMERATED {beamManagement, codebook, nonCodebook, antennaSwitching }, | |
|---|---|---|
| alpha | Alpha | OPTIONAL, -- Need S |
| p0 | INTEGER (−202..24) | OPTIONAL, -- Cond Setup |
| pathlossReferenceRS | PathlossReferenceRS-Config | OPTIONAL, -- Need M |

| | |
|---|---|
| srs-PowerControlAdjustmentStates | ENUMERATED { sameAsFci2, |
| | separateClosedLoop} |

```
OPTIONAL, -- Need S
  ...,
  [[
```

| | | |
|---|---|---|
| pathlossReferenceRSList-r16 | SetupRelease | OPTIONAL |
| | { PathlossReferenceRSList-r16} | |

```
-- Need M
  ]],
  [[
```

| | | |
|---|---|---|
| usagePDC-r17 | ENUMERATED {true} | OPTIONAL, -- Need R |

| | |
|---|---|
| availableSlotOffsetList-r17 | SEQUENCE (SIZE(1..4)) |
| | OF AvailableSlotOffset-r17 |

OPTIONAL, -- Need R

| | | |
|---|---|---|
| followUnifiedTCIstateSRS-r17 | ENUMERATED {enabled} | OPTIONAL -- Need R |

]]
}
maxNrofSRS-SignalReception ::= 4 -- “4” is an exmaple number and can be changed to another
positive number, e.g., 8, 16, 64, 128, 192,...

In some embodiments, with regard to two or more target receiving TRPs, the network entity 410 configures one or more lists of associated CSI-RS resources for signal reception for SRS for NCB/AS by RRC signaling (e.g., channelMeasAssociatedCSI-RSList field(s) in the aperiodic filed, semi-persistent field, and/or periodic field), and down-select at least one of the associated CSI-RS resources by MAC CE or DCI.

In one example, for semi-persistent SRS, the network entity 410 can select one associated CSI-RS resource index from a list of configured associated CSI-RS resources for signal reception (e.g., channelMeasAssociatedCSI-RSList in the semi-persistent field), and include the selected index in a MAC CE field, e.g., associated CSI-RS resource index, of a MAC CE. In one implementation, the size of the MAC CE field can be determined by the UE and network entity 410 as ceil(log₂ C) bits, where C is the number of the associated CSI-RS resources for signal reception configured by RRC.

In some embodiments, the size of the MAC CE field is a fixed number of bits. In one example, the fixed number is the maximum number of associated CSI-RS resources (e.g., maxNrofSRS-SignalReception). In another example, the fixed number is ceil(log₂ C), where Cis the maximum number of associated CSI-RS resources for signal reception. In another example, for semi-persistent SRS, the network entity 410 can select one or more than one associated CSI-RS resource index(es) by a MAC CE field e.g., associated CSI-RS resource index(es) of a MAC CE, where the MAC CE field can be a bit-map and each bit indicates whether a particular CSI-RS is selected or not. In one implementation, the size of the MAC CE is a fixed number of bits. For example, the fixed number is equal to or larger than the maximum number of associated CSI-RS resources (e.g., maxNrofSRS-SignalReception).

In one example, for aperiodic SRS, the network entity 410 can select one associated CSI-RS resource index from the list of associated CSI-RS resources (e.g., channelMeasAssociatedCSI-RSList in the aperiodic field) by a DCI field, e.g., associated CSI-RS resource index, of a DCI. The bit-width for the DCI field can be ceil(log₂ C), where Cis the number of candidates associated CSI-RS resources configured by RRC. In another example, for aperiodic SRS, the network entity 410 can select one or more than one associated CSI-RS resource index(es) by a DCI field e.g., associated CSI-RS resource index(es), where the DCI field can be a bit-map and each bit indicates whether the CSI-RS is selected or not.

In some embodiments, with regard to interference suppression, the network entity 410 may configure an additional associated CSI-RS resource for interference suppression for SRS for NCB/AS. In an example, the network entity 410 can configure an associated CSI-RS resource for interference suppression by the following RRC parameter interferenceMeasAssociatedCSI-RS as shown in the example ASN. 1 code 2 below.

Example ASN.1 code 2

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) |
| | OF SRS-ResourceId |

OPTIONAL, -- Cond Setup

| resourceType | CHOICE { | |
|---|---|---|
| aperiodic | SEQUENCE { | |
| aperiodicSRS-ResourceTrigger | INTEGER (1..maxNrofSRS- | |
| | TriggerStates-1), | |
| csi-RS | NZP-CSI-RS-ResourceId | OPTIONAL, -- |
| | | Cond NonCodebook |
| slotOffset | INTEGER (1..32) | OPTIONAL, -- Need S |

```
      ...,
      [[
```

| | |
|---|---|
| aperiodicSRS-ResourceTriggerList | SEQUENCE (SIZE(1..maxNrofSRS- |
| | TriggerStates-2)) OF |
| INTEGER (1..maxNrofSRS-TriggerStates-1) | OPTIONAL -- Need M |

```
      ]],
        [[
```

| | |
|---|---|
| channelMeasAssociatedCSI-RSList | SEQUENCE (SIZE(1..maxNrofSRS- |
| SignalReception)) OF NZP-CSI-RS-ResourceId | OPTIONAL, -- Cond NonCodebook or |

antenna switching

| | |
|---|---|
| interferenceMeasAssociatedCSI-RS | NZP-CSI-RS-ResourceId |

```
OPTIONAL, -- Cond NonCodebook or antenna switching
        ]]
    },
```

| semi-persistent | SEQUENCE { | |
|---|---|---|
| associatedCSI-RS | NZP-CSI-RS-ResourceId | OPTIONAL, -- Cond |

```
NonCodebook
      ...,
        [[
```

| | |
|---|---|
| channelMeasAssociatedCSI-RSList | SEQUENCE (SIZE(1..maxNrofSRS- |
| SignalReception)) OF NZP-CSI-RS-ResourceId | OPTIONAL, -- Cond NonCodebook or |

antenna switching

| | |
|---|---|
| interferenceMeasAssociatedCSI-RS | NZP-CSI-RS-ResourceId |

```
OPTIONAL, -- Cond NonCodebook or antenna switching
        ]]
    },
```

| periodic | SEQUENCE { | |
|---|---|---|
| associatedCSI-RS | NZP-CSI-RS-ResourceId | OPTIONAL, -- Cond |

```
NonCodebook
      ...,
        [[
```

| | |
|---|---|
| channelMeasAssociatedCSI-RSList | SEQUENCE (SIZE(1.. maxNrofSRS- |
| SignalReception)) OF NZP-CSI-RS-ResourceId | OPTIONAL, -- Cond NonCodebook or |

antenna switching

| | |
|---|---|
| interferenceMeasAssociatedCSI-RS | NZP-CSI-RS-ResourceId |

```
OPTIONAL, -- Cond NonCodebook or antenna switching
        ]]
    }
  },
```

| usage | ENUMERATED {beamManagement, codebook, nonCodebook, antennaSwitching}, | |
|---|---|---|
| alpha | Alpha | OPTIONAL, -- Need S |
| p0 | INTEGER (−202..24) | OPTIONAL, -- Cond Setup |
| pathlossReferenceRS | PathlossReferenceRS-Config | OPTIONAL, -- Need M |

| | |
|---|---|
| srs-PowerControlAdjustmentStates | ENUMERATED { sameAsFci2, separateClosedLoop} |

```
OPTIONAL, -- Need S
  ...,
  [[
```

| | | |
|---|---|---|
| pathlossReferenceRSList-r16 | SetupRelease | OPTIONAL |
| | { PathlossReferenceRSList-r16} | |

```
-- Need M
  ]],
  [[
```

| | | |
|---|---|---|
| usagePDC-r17 | ENUMERATED {true} | OPTIONAL, -- Need R |

| | |
|---|---|
| availableSlotOffsetList-r17 | SEQUENCE (SIZE(1..4)) |
| | OF AvailableSlotOffset-r17 |

OPTIONAL, -- Need R

| | | |
|---|---|---|
| followUnifiedTCIstateSRS-r17 | ENUMERATED {enabled} | OPTIONAL -- Need R |

]]
}
maxNrofSRS-SignalReception ::= 4 -- “4” is an exmaple number and can be changed to another
positive number, e.g., 8, 16, 64, 128, 192,...

In an example, the network entity 410 can configure a list of associated CSI-RS resources for interference suppression by the following RRC parameter interferenceMeasAssociatedCSI-RSList as shown in example ASN. 1 code 3 below.

Example ASN.1 code 3

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) |
| | OF SRS-ResourceId |

OPTIONAL, -- Cond Setup

| resourceType | CHOICE { | |
|---|---|---|
| aperiodic | SEQUENCE { | |
| aperiodicSRS-ResourceTrigger | INTEGER (1..maxNrofSRS- | |
| | TriggerStates-1), | |
| csi-RS | NZP-CSI-RS-ResourceId | OPTIONAL, -- |
| | | Cond NonCodebook |
| slotOffset | INTEGER (1..32) | OPTIONAL, ---- Need S |

```
      ...,
      [[
```

| | |
|---|---|
| aperiodicSRS-ResourceTriggerList | SEQUENCE (SIZE(1..maxNrofSRS- |
| | TriggerStates-2)) OF |
| INTEGER (1..maxNrofSRS-TriggerStates-1) | OPTIONAL -- Need M |

```
      ]],
        [[
```

| | |
|---|---|
| interferenceMeasAssociatedCSI-RSList | SEQUENCE (SIZE(1..maxNrofSRS- |

| | |
|---|---|
| InterferenceSuppression)) OF NZP-CSI-RS-ResourceId | OPTIONAL, -- Cond NonCodebook |

```
or antenna switching
      ]]
    },
```

| semi-persistent | SEQUENCE { | |
|---|---|---|
| associatedCSI-RS | NZP-CSI-RS-ResourceId | OPTIONAL, -- Cond |

```
NonCodebook
      ...,
        [[
```

| | |
|---|---|
| interferenceMeasAssociatedCSI-RSList | SEQUENCE (SIZE(1..maxNrofSRS- |

| | |
|---|---|
| InterferenceSuppression)) OF NZP-CSI-RS-ResourceId | OPTIONAL, -- Cond NonCodebook |

```
or antenna switching
        ]]
    },
```

| periodic | SEQUENCE { | |
|---|---|---|
| associatedCSI-RS | NZP-CSI-RS-ResourceId | OPTIONAL, -- Cond |

```
NonCodebook
      ...,
        [[
```

| | |
|---|---|
| interferenceMeasAssociatedCSI-RSList | SEQUENCE (SIZE(1..maxNrofSRS- |

| | |
|---|---|
| InterferenceSuppression)) OF NZP-CSI-RS-ResourceId | OPTIONAL, -- Cond NonCodebook |

```
or antenna switching
        ]]
    }
  },
```

| usage | ENUMERATED {beamManagement, codebook, nonCodebook, antennaSwitching}, | |
|---|---|---|
| alpha | Alpha | OPTIONAL, -- Need S |
| p0 | INTEGER (−202..24) | OPTIONAL, -- Cond Setup |
| pathlossReferenceRS | PathlossReferenceRS-Config | OPTIONAL, -- Need M |

| | |
|---|---|
| srs-PowerControlAdjustmentStates | ENUMERATED |
| | { sameAsFci2, separateClosedLoop} |

```
OPTIONAL, -- Need S
  ...,
  [[
```

| | | |
|---|---|---|
| pathlossReferenceRSList-r16 | SetupRelease | OPTIONAL |
| | { PathlossReferenceRSList-r16} | |

```
-- Need M
  ]],
  [[
```

| | | |
|---|---|---|
| usagePDC-r17 | ENUMERATED {true} | OPTIONAL, -- Need R |

| | |
|---|---|
| availableSlotOffsetList-r17 | SEQUENCE (SIZE(1..4)) OF AvailableSlotOffset-r17 |

OPTIONAL, -- Need R

| | | |
|---|---|---|
| followUnifiedTCIstateSRS-r17 | ENUMERATED {enabled} | OPTIONAL -- Need R |

]]
}
maxNrofSRS-InterferenceSuppression ::= 2 -- “2” is an exmaple number and can be changed to
another positive number, e.g., 8, 16, 64, 128, 192,...

In some embodiments, the network entity 410 may configure a first list of associated CSI-RS resources for signal reception and a second list of associated CSI-RS resources for interference suppression by RRC. In an example, the network entity 410 may configure the first list of associated CSI-RS resources by the RRC parameter channelMeasAssociatedCSI-RSList and the second list of associated CSI-RS resources by the RRC parameter interferenceMeasAssociatedCSI-RSList as shown in an example ASN. 1 code 4 below.

Example ASN.1 code 4

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) |
| | OF SRS-ResourceId |

OPTIONAL, -- Cond Setup

| resourceType | CHOICE { | |
|---|---|---|
| aperiodic | SEQUENCE { | |
| aperiodicSRS-ResourceTrigger | INTEGER (1..maxNrofSRS-TriggerStates-1), | |
| csi-RS | NZP-CSI-RS-ResourceId | OPTIONAL, -- |
| | | Cond NonCodebook |
| slotOffset | INTEGER (1..32) | OPTIONAL, -- Need S |

```
      ...,
      [[
```

| | |
|---|---|
| aperiodicSRS-ResourceTriggerList | SEQUENCE (SIZE(1..maxNrofSRS- |
| | TriggerStates-2)) OF |
| INTEGER (1..maxNrofSRS-TriggerStates-1) | OPTIONAL -- Need M |

```
      ]],
        [[
```

| | |
|---|---|
| channelMeasAssociatedCSI-RSList | SEQUENCE (SIZE(1.. maxNrofSRS- |

| | |
|---|---|
| SignalReception)) OF NZP-CSI-RS-ResourceId | OPTIONAL, -- Cond NonCodebook or |

antenna switching

| | |
|---|---|
| interferenceMeasAssociatedCSI-RSList | SEQUENCE (SIZE(1..maxNrofSRS- |

| | |
|---|---|
| InterferenceSuppression)) OF NZP-CSI-RS-ResourceId | OPTIONAL, -- Cond NonCodebook |

```
or antenna switching
        ]]
    },
```

| semi-persistent | SEQUENCE { | |
|---|---|---|
| associatedCSI-RS | NZP-CSI-RS-ResourceId | OPTIONAL, -- Cond |

```
NonCodebook
      ...,
        [[
```

| | |
|---|---|
| channelMeasAssociatedCSI-RSList | SEQUENCE (SIZE(1.. maxNrofSRS- |

| | |
|---|---|
| SignalReception)) OF NZP-CSI-RS-ResourceId | OPTIONAL, -- Cond NonCodebook or |

antenna switching

| | |
|---|---|
| interferenceMeasAssociatedCSI-RSList | SEQUENCE (SIZE(1..maxNrofSRS- |

| | |
|---|---|
| InterferenceSuppression)) OF NZP-CSI-RS-ResourceId | OPTIONAL, -- Cond NonCodebook |

```
or antenna switching
        ]]
    },
```

| periodic | SEQUENCE { | |
|---|---|---|
| associatedCSI-RS | NZP-CSI-RS-ResourceId | OPTIONAL, -- Cond |

```
NonCodebook
      ...,
        [[
```

| | |
|---|---|
| channelMeasAssociatedCSI-RSList | SEQUENCE (SIZE(1.. maxNrofSRS- |

| | |
|---|---|
| SignalReception)) OF NZP-CSI-RS-ResourceId | OPTIONAL, -- Cond NonCodebook or |

antenna switching

| | |
|---|---|
| interferenceMeasAssociatedCSI-RSList | SEQUENCE (SIZE(1..maxNrofSRS- |

| | |
|---|---|
| InterferenceSuppression)) OF NZP-CSI-RS-ResourceId | OPTIONAL, -- |
| | Cond NonCodebook |

```
or antenna switching
        ]]
    }
  },
```

| usage | ENUMERATED {beamManagement, codebook, nonCodebook, antennaSwitching}, | |
|---|---|---|
| alpha | Alpha | OPTIONAL, -- Need S |
| p0 | INTEGER (−202..24) | OPTIONAL, -- Cond Setup |
| pathlossReferenceRS | PathlossReferenceRS-Config | OPTIONAL, -- Need M |

| | |
|---|---|
| srs-PowerControlAdjustmentStates | ENUMERATED |
| | {sameAsFoi2, separateclosedLoop} |

```
OPTIONAL, -- Need S
  ...,
  [[
```

| | | |
|---|---|---|
| pathlossReferenceRSList-r16 | SetupRelease | OPTIONAL |
| | { PathlossReferenceRSList- | |
| | r16} | |

```
-- Need M
  ]],
  [[
```

| | | |
|---|---|---|
| usagePDC-r17 | ENUMERATED {true} | OPTIONAL, -- Need R |

| | |
|---|---|
| availableSlotOffsetList-r17 | SEQUENCE (SIZE(1..4)) OF |
| | AvailableSlotOffset-r17 |

OPTIONAL, -- Need R

| | | |
|---|---|---|
| followUnifiedTCIstateSRS-r17 | ENUMERATED {enabled} | OPTIONAL -- |
| | | Need R |

]]
}
maxNrofSRS-SignalReception ::= 4 -- “4” is an exmaple number and can be changed to another
positive number, e.g., 8, 16, 64, 128, 192,...
maxNrofSRS-InterferenceSuppression ::= 2 -- “2” is an exmaple number and can be changed to
another positive number, e.g., 8, 16, 64, 128, 192,...

In some embodiments, with regard to two or more victim TRPs for interference suppression, the network entity 410 may configure a list of associated CSI-RS resources for interference suppression for SRS for NCB/AS by RRC signaling (e.g., interferenceMeasAssociatedCSI-RSList field(s) in the aperiodic filed, semi-persistent field, and/or periodic field), and down-select at least one of the associated CSI-RS resources by MAC CE or DCI.

In one example, for semi-persistent SRS, the network entity 410 can select one associated CSI-RS resource index from the list of configured candidates associated CSI-RS resources for interference suppression (e.g., interferenceMeasAssociatedCSI-RSList in the semi-persistent field) by a MAC CE field, e.g., associated CSI-RS resource index, of a MAC CE. In one implementation, the size of the MAC CE field can be determined by the UE and network entity 410 as ceil(log₂ C) bits, where C is the number of the associated CSI-RS resources configured by RRC. In some embodiments, the size of the MAC CE field is a fixed number of bits. In one example, the fixed number is the maximum number of associated CSI-RS resources (e.g., maxNrofSRS-InterferenceSuppression). In another example, the fixed number is ceil(log₂ C), where C is the maximum number of associated CSI-RS resources for interference suppression. In another example, for semi-persistent SRS, the network entity 410 can select one or more than one associated CSI-RS resource index(es) by a MAC CE field e.g., associated CSI-RS resource index(es) of a MAC CE, where the MAC CE field can be a bit-map and each bit indicates whether a particular CSI-RS is selected or not. In one implementation, the size of the MAC CE is a fixed number of bits. For example, the fixed number is equal to or larger than the maximum number of associated CSI-RS resources (e.g., maxNrofSRS-Suppression).

In one example, for aperiodic SRS, the network entity 410 can select one associated CSI-RS resource index from the list of associated CSI-RS resources for interference suppression (e.g., interferenceMeasAssociatedCSI-RSList in the aperiodic field) by a DCI field, e.g., associated CSI-RS resource index of a DCI. The bit-width for the DCI field can be ceil(log₂ C), where Cis the number of candidates associated CSI-RS resources configured by RRC. In another example, for aperiodic SRS, the network entity 410 can select one or more than one associated CSI-RS resource index(es) by a DCI field e.g., associated CSI-RS resource index(es), where the DCI field can be a bit-map and each bit indicates whether the CSI-RS is selected or not.

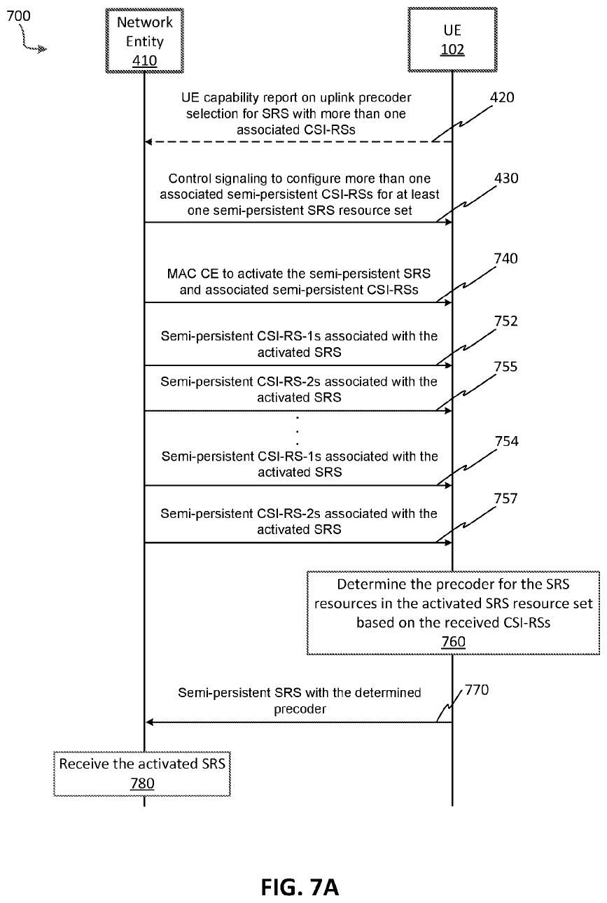

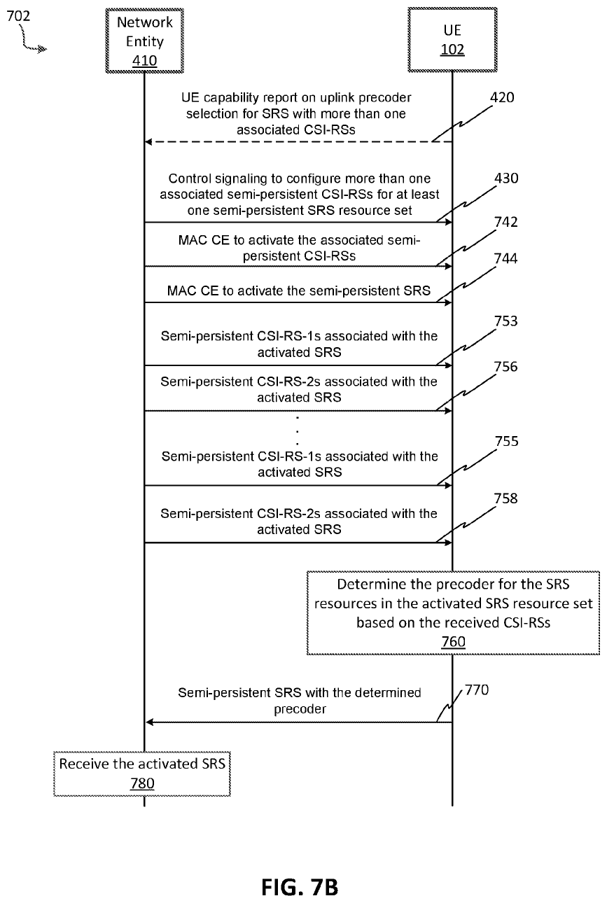

FIG. 7A illustrates an example signaling diagram 700 for precoder determination in a non-codebook (NCB) semi-persistent uplink scheme with multi-TRPs, according to some embodiments. In an embodiment, the network entity 410 transmits the associated CSI-RSs in a repeated manner (e.g., periodic or semi-periodic) to the UE device. For periodic CSI-RS, the network entity 410 transmits the associated CSI-RS based on the configured periodicity and slot offset. For semi-persistent CSI-RS, the network entity 410 transmits a MAC CE to activate the CSI-RS and transmits the CSI-RS based on the configured periodicity and slot offset. The network entity 410 may trigger the associated semi-persistent CSI-RSs and semi-persistent SRS resource set using a single MAC CE, as shown in FIG. 7A or separate MAC CEs, as shown in FIG. 7B.

In FIG. 7A, the UE 102 transmits 420 the UE capability report on uplink precoder selection for SRS with more than one associated CSI-RSs to the network entity 410 (e.g., a gNB). The network entity 410 transmits 430 control signaling to configure more than one associated semi-persistent CSI-RSs for at least one semi-persistent SRS resource set. The network entity 410 then transmits 740 a MAC CE to the UE device to activate the semi-persistent SRS and associated semi-persistent CSI-RSs. The network entity 410 transmits 752 and 754, multiple first semi-persistent CSI-RS-1s associated with the activated SRS. The network entity 410 transmits 755 and 757 multiple second semi-persistent CSI-RS-2s associated with the activated SRS. Upon receiving the CSI-RS-1s and CSI-RS-2s, the UE device 102 determines 760 the precoder for the SRS resources in the activated SRS resource set based on the received semi-persistent CSI-RSs. The UE device 102 transmits 770 the semi-persistent SRS with the determined precoder to the network entity 410. The network entity 410 receives 780 the activated SRS.

FIG. 7B illustrates another example signaling diagram for precoder determination in a semi-persistent uplink scheme with multi-TRPs, according to some embodiments. The call flow diagram 702 is similar to the call flow diagram 700, except that the network entity 410 transmits 742 and 744 two separate MAC CEs to respectively activate the associated semi-persistent CSI-RSs and the semi-persistent SRS.

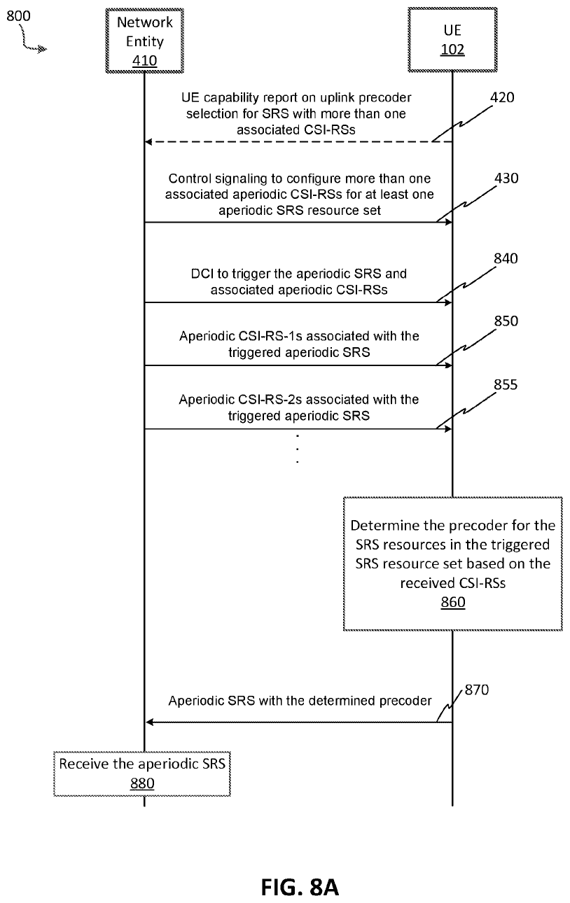

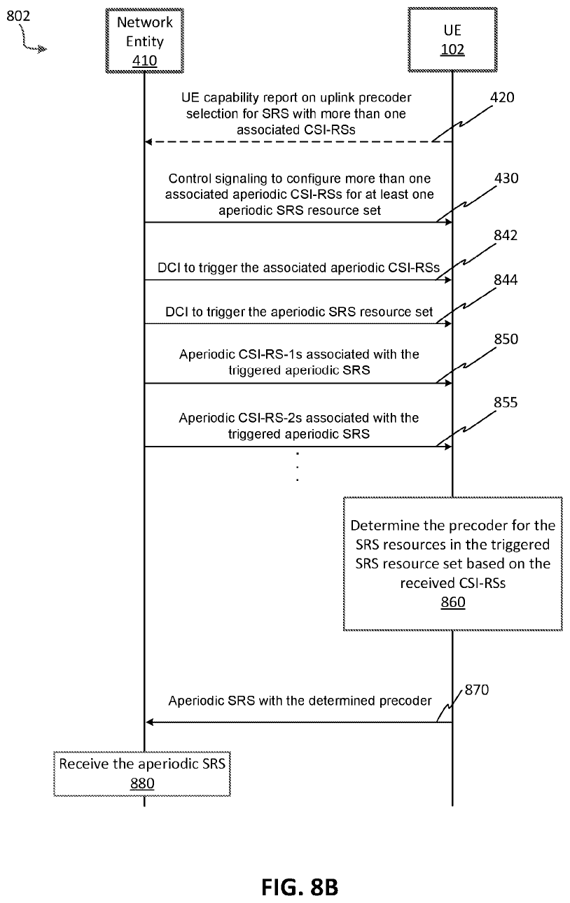

FIG. 8A illustrates an example signaling diagram for precoder determination in an aperiodic uplink scheme with multi-TRPs, according to some embodiments. For aperiodic CSI-RS, the network entity 410 may trigger the associated aperiodic CSI-RS resource(s) and the corresponding SRS by the SRS request field in one DCI as shown in FIG. 8A. Alternatively, the network entity 410 may trigger the associated aperiodic CSI-RS resource(s) and the corresponding SRS by separate DCIs as shown in FIG. 8B. In FIG. 8A, the network entity 410, after transmitting 430 the control signaling to configure more than one associated aperiodic CSI-RSs for at least one aperiodic SRS resource set, transmits 840 a DCI to trigger the aperiodic SRS and associated aperiodic CSI-RSs. The network entity 410 then transmits 850 and 855 aperiodic CSI-RS-1s and CSI-RS-2s (of two TRPs respectively) associated with the triggered aperiodic SRS. The UE device 102 determines 860 the precoder for the SRS resources in the triggered SRS resource set based on the received CSI-RSs and transmits 870 aperiodic SRS with the determined precoder. The network entity 410 receives 880 the aperiodic SRS.

In some embodiments, the network entity 410 transmits the associated CSI-RS resource(s) at the slot with a slot offset configured by RRC signaling from the slot with the last symbol of the DCI. In some embodiments, the network entity 410 transmits the associated CSI-RS resource(s) in the same slot as the slot with the last symbol of the DCI. In some embodiments, the network entity 410 transmits the associated CSI-RS at a reference slot indicated by the DCI. The last symbol of the trigger associated CSI-RS resource(s) should be at least Z symbols before the first symbol of the triggered aperiodic SRS including the timing advance, where Z may be predefined, e.g., Z=42, or Z may be reported by UE capability.

FIG. 8B illustrates another example signaling diagram for precoder determination in an aperiodic uplink scheme with multi-TRPs, according to some embodiments. The call flow diagram 802 is similar to the call flow diagram 800, except that the network entity 410 transmits 842 and 844 two separate DCIs to respectively trigger the associated aperiodic CSI-RSs and the aperiodic SRS resource set.

For an SRS resource with two lists of associated CSI-RS resource(s), the network entity 410 may transmit the two lists of associated CSI-RS resource(s) in the first slot. Alternatively, the network entity 410 may transmit the two lists of the associated CSI-RS resources in consecutive slots, where the first list is transmitted from the first slot and the second list is transmitted from the next slot after the first slot. In one example, the first slot may be the slot with a slot offset configured by RRC signaling from the slot with the last symbol of the DCI. In another example, the first slot may be the slot with the last symbol of the DCI. In another example, the first slot may be a reference slot indicated by the DCI.

In an embodiment, the UE can derive the uplink precoder based on the associated CSI-RS resources for each SRS resource in an SRS resource set, and transmit the precoded SRS resource(s) based on the determined precoder(s).

In one example, if there are two or more associated CSI-RS resources for signal reception, the UE may derive the uplink precoder as follows:

$${USV}^{H} = \frac{1}{NM} {\sum }_{k = 1}^{M} {\sum }_{j = 1}^{N} {H}_{j , k} {H}_{j , k}^{H}$$

Where H_{j,k} indicates the estimated channel for associated CSI-RS resource k at subcarrier j; M is the number of associated CSI-RS resources.

In another example, the UE may derive the uplink precoder as follows:

$${USV}^{H} = \frac{1}{NM} {\sum }_{k = 1}^{M} {β}_{k} {\sum }_{j = 1}^{N} {H}_{j , k} {H}_{j , k}^{H}$$

Where βₖ is a scaling factor for associated CSI-RS resource k and 0≤βₖ≤1. In some implementation, the network entity 410 may configure the value of the scaling factor for each associated CSI-RS resource by RRC signaling. In some implementation, the network entity 410 may dynamically configure the value of the scaling factor for each associated CSI-RS by layer 1 or layer 2 signaling, e.g., DCI or MAC CE. In some implementation, the scaling factor is determined based on the linear reference signal receiving power (RSRP) for the associated CSI-RS resources. The network entity 410 may configure whether to enable the scaling factor by RRC signaling. In one example, it can be calculated as follows:

$${β}_{k} = \frac{M {α}_{k}}{{\sum }_{k = 1}^{M} {α}_{k}} \\ {α}_{k} = \frac{{\sum }_{k = 1}^{M} {γ}_{k}}{{γ}_{k}}$$

In another example, if there is at least 1 associated CSI-RS resource for interference suppression, the UE can derive the precoder based on the associated CSI-RSs for signal reception and associated CSI-RSs for interference suppression. In one example, the UE calculates the precoder for an SRS resources in a resource set as follows:

\tilde{V}=[Vₛ,Ŵ₁,Ŵ₂, . . . ,Ŵ_{Q}]

\tilde{W}=(\tilde{V}^{H}\tilde{V})⁻¹\tilde{V}^{H}

Where the precoder is the first row or matrix \tilde{W} with normalization; Vₛ is the s^{th} column of eigenvector V calculated from the associated CSI-RS(s) for signal reception; Ŵ_{q} is the first row of the eigenvector of the associated CSI-RS resource q for interference suppression; Q is the number of associated CSI-RS resources for interference suppression.

If the UE enables analog beamforming, the UE may determine the uplink transmission beam(s) to transmit the precoded SRS based on the downlink reception beam(s) used to receive the associated CSI-RSs for signal reception. In some embodiments, the UE receives the associated CSI-RS based on a single downlink reception beam. Then the UE may transmit the precoded SRS based on a single uplink transmission beam, which is based on the single downlink reception beam used to receive the associated CSI-RSs. In some embodiments, the UE receives each associated CSI-RS based on a separate downlink reception beam. Then, the UE may transmit the precoded SRS based on more than one uplink beams, where each uplink transmission beam is based on the downlink reception beam used to receive each associated CSI-RS.

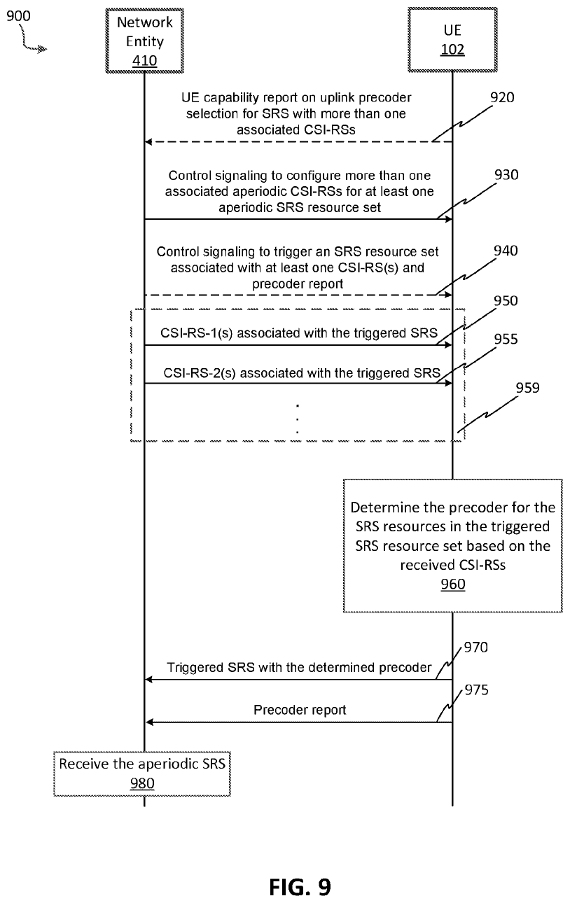

FIG. 9 illustrates an example signaling diagram for precoder determination and for transmitting an uplink precoder report with associated CSI-RS, according to some embodiments. As shown, the call flow diagram 900 illustrates the procedure for transmitting 975 a precoder report for SRS for antenna switching (AS). The precoder report provides a mechanism to maintain a common understanding between the network entity 410 and the UE device 102 on the precoder applied for SRS (e.g., AS type SRS). The network entity 410 can recover the downlink channel based on the measurement of the precoded SRS for AS as follows:

$${H}_{j}^{( DL )} = {\tilde{H}}_{j} {\tilde{W}}^{H}$$

### Where

$${H}_{j}^{( DL )}$$

indicates the estimated downlink channel at subcarrier j; \tilde{H}ⱼ is the estimated Where channel from the SRS for AS at subcarrier j; \tilde{W} is the reported precoder.

The UE device 102 transmits 920 a UE capability report regarding uplink precoder selection for SRS with more than one associated CSI-RS (similar to operation 420 in FIG. 4). The UE device 102 receives 930 control signaling from the network entity 410 to configure more than one associated aperiodic CSI-RSs for at least one aperiodic SRS resource set. The network entity 410 transmits 940 control signaling to trigger an SRS resource set associated with at least one CSI-RS(s) and precoder report. The network entity 410 then transmits 950 and 955, 959 multiple CSI-RS-1s and CSI-RS-2s associated with the triggered SRS. The UE device 102 determines 960 the precoder for the SRS transmitted in the triggered SRS resource set based on the received CSI-RSs. The UE device 102 transmits 970 the triggered SRS with the determined precoder, and transmits 975 the precoder report to the network entity 410. The network entity 410 receives 980 the aperiodic SRS and the precoder report.

Unlike conventional operations, in aspects of this disclosure, the network entity 410 transmits 930 control signaling related to the precoder report to the UE, which may include the parameters for precoder quantization, and uplink resources for the precoder report. In addition, the network entity 410 may transmit 930 the control signaling to configure at least one associated CSI-RS for an SRS resource set for the UE to calculate the precoder. The network entity 410 may transmit an RRC message (e.g., RRCReconfiguration message) including such control signaling. Alternatively, the network entity 410 may transmit some control signaling, e.g., uplink resource for precoder report, by MAC CE or DCI.

In some cases, the network entity 410 may further trigger the precoder report by MAC CE or DCI. For semi-persistent SRS and semi-persistent precoder report, the network entity 410 may activate the precoder report by MAC CE. For aperiodic SRS and aperiodic precoder report, the network entity 410 may trigger the precoder report by DCI.

In some cases, the UE may quantize the precoder based on the received control signaling on quantization parameters and transmit the precoder to the network entity 410 based on the configured or indicated uplink resource for precoder report.

In some cases, the network entity 410 may estimate the downlink channel based on the received SRS and precoder report, and identify the downlink precoder for downlink transmission based on the downlink channel estimate.

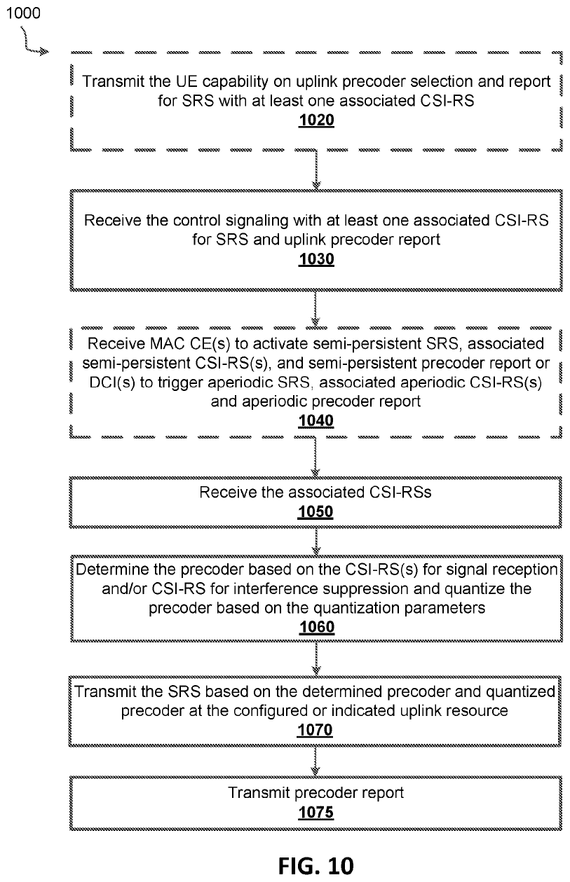

FIG. 10 is a flow diagram depicting a method for precoder determination and for transmitting an uplink precoder report with associated CSI-RS by a UE device, according to some embodiments. The flow diagram 1000 illustrates the behavior of the UE device 102 for uplink precoder report with associated CSI-RS. As shown, the UE device transmits 1020 the UE capability on uplink precoder selection and report for SRS with at least one associated CSI-RS 1020. The UE device receives 1030 the control signaling with at least one associated CSI-RS for SRS and uplink precoder report. The UE device receives 1040 MAC CE(s) to activate semi-persistent SRS, associated semi-persistent CSI-RS(s), and semi-persistent precoder report. Alternatively, the UE device receives 1040 DCI(s) to trigger aperiodic SRS, associated aperiodic CSI-RS(s) and aperiodic precoder report. The UE device receives 1050 the associated CSI-RSs and determines 1060 the precoder based on the CSI-RS(s) for signal reception and/or CSI-RS for interference suppression and quantize the precoder based on the quantization parameters. The UE device transmits 1070 the SRS based on the determined precoder and quantized precoder at the configured or indicated uplink resource. The UE device transmits 1075 the precoder report. In some cases, transmitting the precoder report is based on a quantized amplitude and a quantized phase for each precoding weight coefficient, as configured by a radio resource control (RRC) signaling.

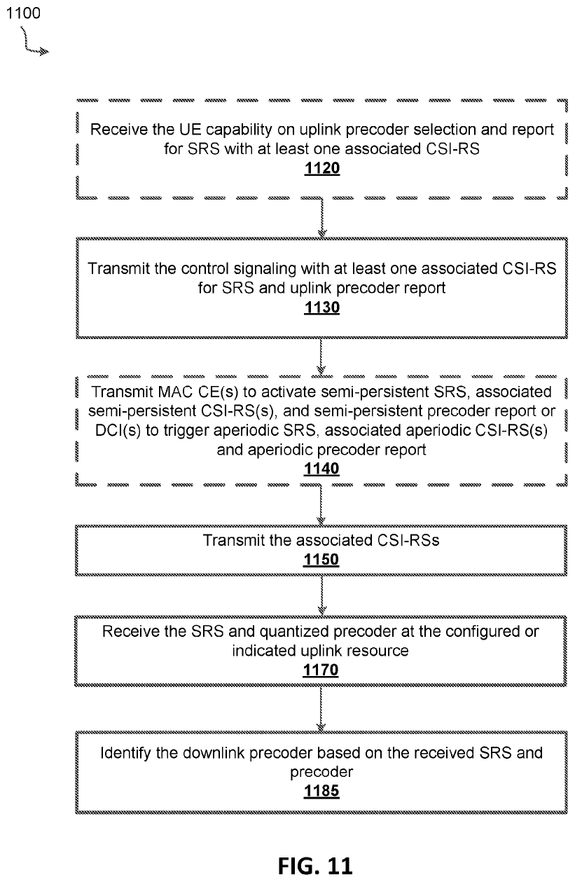

FIG. 11 is a flow diagram depicting a method for precoder determination and for receiving an uplink precoder report with associated CSI-RS by a network entity, according to some embodiments. The flow diagram 1100 illustrates the network side (gNB) behavior for uplink precoder report with associated CSI-RS. The method shown in the flow diagram 1100 on the network entity side may correspond to the method of the flow diagram 1000 on the UE device side. The network entity (optionally) receives 1120 the UE capability on uplink precoder selection and report for SRS with at least one associated CSI-RS. The network entity transmits 1130 the control signaling with at least one associated CSI-RS for SRS and uplink precoder report. The network entity (optionally) transmits 1140 MAC CE(s) to activate semi-persistent SRS, associated semi-persistent CSI-RS(s), and semi-persistent precoder report. Alternatively, the network entity transmits DCI(s) to trigger aperiodic SRS, associated aperiodic CSI-RS(s) and aperiodic precoder report. The network entity transmits 1150 the associated CSI-RSs to the UE device. The network entity receives 1170 the SRS and quantized precoder at the configured or indicated uplink resource. The network entity identifies 1185 the downlink precoder based on the received SRS and precoder.

In an embodiment, for periodic SRS for AS, the network entity 410 may configure the uplink resource, e.g., a list of PUCCH resources or a PUCCH resource, for precoder report by RRC signaling. The network entity 410 may further configure the report periodicity and slot offset. For semi-persistent SRS for AS, the network entity 410 may configure the uplink resource, e.g., a list of PUCCH resources or a PUCCH resource or PUSCH, and report periodicity and slot offset, for precoder report by RRC signaling. For PUSCH based report, the network entity 410 may further configure the PUSCH resource by a DCI associated with a configured scheduling radio network temporary ID (CS-RNTI). For aperiodic SRS for AS, the network entity 410 may configure the report slot offset list by RRC signaling and indicate the uplink resource, e.g., PUCCH or PUSCH, for the precoder report by DCI. In one example, the DCI may be the one used to trigger the aperiodic SRS for AS. In another example, the DCI may be a separate DCI used to trigger the aperiodic SRS for AS.

In one example the network entity 410 can configure the following RRC parameters (underlined parameters below) for the precoder report.

Example with Underlined RRC parameters

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) OF SRS-ResourceId |

OPTIONAL, -- Cond Setup

| resourceType | CHOICE { | |
|---|---|---|
| aperiodic | SEQUENCE { | |
| aperiodicSRS-ResourceTrigger | INTEGER (1..maxNrofSRS-TriggerStates-1), | |
| csi-RS | NZP-CSI-RS-ResourceId | OPTIONAL, -- |
| | | Cond NonCodebook |
| slotOffset | INTEGER (1..32) | OPTIONAL, -- Need S |

```
      ...,
      [[
```

| | |
|---|---|
| aperiodicSRS-ResourceTriggerList | SEQUENCE (SIZE(1..maxNrofSRS-TriggerStates-2)) OF |
| INTEGER (1..maxNrofSRS-TriggerStates-1) | OPTIONAL -- Need M |

]],

| | |
|---|---|
| reportSlotOffsetList | SEQUENCE (SIZE (1..maxNrofUL-Allocations)) OF |

INTEGER (0..32) -- Cond antenna switching
},

| semi-persistent | SEQUENCE { | |
|---|---|---|
| associatedCSI-RS | NZP-CSI-RS-ResourceId | OPTIONAL, -- |
| | | Cond |

NonCodebook

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI-Resource |

}, -- Cond antenna switching

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1.. maxNrofUL-Allocations)) OF |

```
INTEGER (0..32),
        }, -- Cond antenna switching
      ...
    },
```

| periodic | SEQUENCE { | |
|---|---|---|
| associatedCSI-RS | NZP-CSI-RS-ResourceId | OPTIONAL, -- |
| | | Cond |

NonCodebook

| | |
|---|---|
| reportSlotConfig | CSI-ReportPeriodicityAndOffset, |
| pucch-CSI-ResourceList | SEQUENCE (SIZE (1..maxNrofBWPs)) OF PUCCH-CSI-Resource -- |

```
Cond antenna switching
      ...
    }
  },
```

| usage | ENUMERATED {beamManagement, codebook, nonCodebook, antennaSwitching}, | |
|---|---|---|
| alpha | Alpha | OPTIONAL, -- Need S |
| p0 | INTEGER (−202..24) | OPTIONAL, -- |
| | | Cond Setup |
| pathlossReferenceRS | PathlossReferenceRS-Config | OPTIONAL, -- Need M |

| | |
|---|---|
| srs-PowerControlAdjustmentStates | ENUMERATED { sameAsFci2, separateClosedLoop) |

```
OPTIONAL, -- Need S
  ...,
  [[
```

| | | |
|---|---|---|
| pathlossReferenceRSList-r16 | SetupRelease { PathlossReferenceRSList- | OPTIONAL |
| | r16} | |

```
-- Need M
  ]],
  [[
```

| | | |
|---|---|---|
| usagePDC-r17 | ENUMERATED {true} | OPTIONAL, -- Need R |

| | |
|---|---|
| availableSlotOffsetList-r17 | SEQUENCE (SIZE(1..4)) OF AvailableSlotOffset-r17 |

OPTIONAL, -- Need R

| | | |
|---|---|---|
| followUnifiedTCIstateSRS-r17 | ENUMERATED {enabled} | OPTIONAL -- Need R |

]]
}

In some embodiments, the network entity 410 may configure the precoder quantization related parameters by RRC signaling, including at least one of the following:
1. The number of horizontal antenna ports (N1);
2. The number of horizontal oversampling factors (O1);
3. The number of horizontal antenna ports (N2);
4. The number of horizontal oversampling factors (O2);
5. The number of selected beams (L);
6. The number of strongest coefficients (Kc);
7. The number of bits for amplitude step size for a non-zero coefficient (X1); or
8. The number of bits for phase for a non-zero coefficient (X2).

In some embodiments, at least one of the parameters above may be predefined. For example, O1 and O2 may be defined as 1, X1 and X2 may be predefined as 3, and Kc may be predefined as N1*N2*U, where U is the total number of antenna ports across the SRS resources in a resource set.

In some embodiments, the UE quantizes and reports the precoder applied for the most recent SRS for AS associated with the measured CSI-RS based on the received quantization schemes.

In some embodiments, the UE quantizes each coefficient based on the configured or predefined Number of bits for amplitude for a non-zero coefficient and Number of bits for phase for a non-zero coefficient. In one example, the amplitude can be quantized as

$$[ 0 , \frac{1}{\sqrt{{2}^{{2}^{( {x}_{1} - 2 )}}}} , \frac{1}{\sqrt{{2}^{{2}^{( {x}_{1} - 1 )}}}} , … , 1 ] .$$

In another example, the phase can be quantized as

$$[ {e}^{j \frac{2 π}{{2}^{{X}_{2}}}} , {e}^{j \frac{2 π \times 2}{{2}^{{X}_{2}}}} , {e}^{j \frac{2 π \times 3}{{2}^{{X}_{2}}}} , … , 1 ] .$$

Then the UE can report the amplitude and phase for each coefficient from the precoder applied to precoded SRS to the network entity 410.

In some embodiments, the UE quantizes the precoder based on two stage precoder as follows:

V=W₁W₂

Where W1 is the spatial domain basis and is selected from a codebook generated as follows:

$${W}_{1} = [ \begin{matrix}B & 0 \\ 0 & B\end{matrix} ] \\ B = [ \begin{matrix}{b}_{1} & {b}_{2} & … & {b}_{L}\end{matrix} ] \\ {b}_{l} = {u}_{m} ⊗ {v}_{n} \\ {u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T} \\ {v}_{n} = {[ \begin{matrix}1 & {e}^{\frac{j 2 π n}{{N}_{2} {O}_{2}}} & … & {e}^{\frac{j 2 π ( {N}_{2} - 1 ) n}{{N}_{2} {O}_{2}}}\end{matrix} ]}^{T}$$

Where, Ø denotes Kronecker product. The codebook contains the precoders with different value of m and n. Denote the codebook to be W, the W1 and W2 can be calculated based on W^{H}V, where W1 is the strongest 2L rows for matrix W^{H}V, and W2 includes the spatial domain basis combination factors, where

$${W}_{2} = {W}_{1}^{H} V .$$

Then the UE may report L beam index(es) selected from the codebook and the strongest Kc coefficients for W2 as well as the index(es) within W2 for the strongest Kc coefficients.

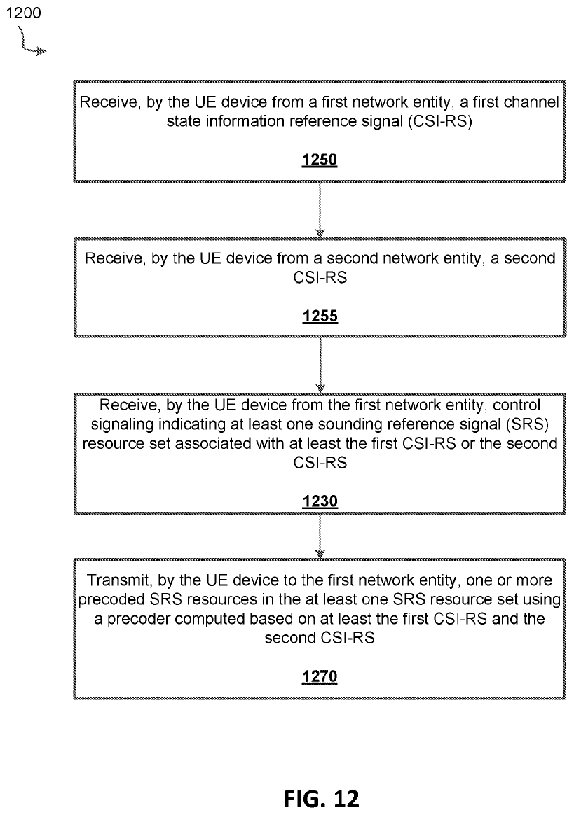

FIG. 12 is a flow diagram depicting a method of precoder determination by a UE device in multi-TRP applications, according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method of the flow diagram 1200 is performed by a UE device, such as the UE device 102. The UE device may include one or more radio frequency (RF) modems, a processor coupled to the one or more RF modems, and at least one non-transient memory storing executable instructions to manipulate at least one of the processor or the RF modems to perform the method of the flow diagram 1200. A network entity may perform a complimentary method to interact with the UE device performing the method (see call flow diagrams 400 and 700 in FIGS. 4 and 7A, for example).

With reference to FIG. 12, the flow diagram 1200 illustrates example functions used by various embodiments. Although specific function blocks (“blocks”) are disclosed in the flow diagram 1200, such blocks are examples. That is, embodiments are well suited to performing various other blocks or variations of the blocks recited in method. It is appreciated that the blocks in method may be performed in an order different than presented, and that not all of the blocks in method may be performed.

As shown in FIG. 12, the UE device receives 1250 from a first network entity, a first CSI-RS (similar to 450 of FIG. 4, 850 of FIG. 8A, among others herein). For example, the first network entity may include a first one of multiple TRPs. The UE device receives 1255, from a second network entity (e.g., a second one of the multiple TRPs), a second CSI-RS (similar to 455 of FIG. 4 or 855 of FIG. 8A).

The UE device receives 1230 from the network entity, control signaling indicating at least one SRS resource set associated with at least the first CSI-RS or the second CSI-RS (similar to 430 of FIGS. 4, 8A, and 8B). The UE device transmits 1270, to the first network entity, one or more precoded SRSs in the at least one SRS resource set using a precoder computed based on at least the first CSI-RS and the second CSI-RS.

In some embodiments, the UE device further receives, from at least a third network entity, a third CSI-RS. The UE device determines the precoder for transmitting the one or more precoded SRSs based on the first CSI-RS, the second CSI-RS, and the third CSI-RS such that the precoded SRSs suppress interference at least to signals received at the third network entity.

In some embodiments, the UE device further receives, from the first network entity, a second control signaling for triggering the at least one SRS resource set associated with the first CSI-RS corresponding to the second control signaling or the second CSI-RS corresponding to the second control signaling. The first network entity and the second network entity are transparent to each other.

In some embodiments, the UE device further transmits, to the first network entity, an indication that the UE device is capable of uplink precoder selection for SRS associated with more than one CSI-RSs (e.g., CSI-RSs in multi-TRP scenarios, not merely in multiple instances from a single TRP). For example, the indication may include at least one of: (1) a maximum number of associated CSI-RS resources for signal reception for an SRS resource set for non-codebook (NCB) uplink transmission schemes; (2) a maximum number of associated CSI-RS resources for interference suppression for an SRS resource set for NCB; (3) that the UE supports associated CSI-RS resource for an SRS resource set for antenna switching (AS); (4) a maximum number of associated CSI-RS resources for signal reception for an SRS resource set for AS; or (5) a maximum number of associated CSI-RS resources for interference suppression for an SRS resource set for AS.

In some embodiments, receiving the control signaling (e.g., a first control signaling) includes at least one of: receiving a first list of CSI-RS resources associated with signal reception at the UE device, the first list of CSI-RS comprising at least the first CSI-RS or the second CSI-RS; or receiving a second list of CSI-RS resources associated with interference suppression caused by signal transmissions at the UE device, the second list of CSI-RS comprising a third CSI-RS from a victim network entity.

In some embodiments, receiving the control signaling (e.g., a second control signaling) includes receiving a radio resource control (RRC) signaling from the first network entity or the second network entity.

In some embodiments, the UE device further receives a media access control (MAC) control element (CE) for activating a semi-persistent SRS and associated semi-persistent CSI-RSs. Alternatively, the UE device further receives a downlink control information (DCI) to trigger aperiodic SRS and associated aperiodic CSI-RSs.

In some embodiments, the MAC-CE or the DCI jointly triggers, at the UE device, the SRS resource set and the associated first CSI-RS or second CSI-RS.

In some embodiments, the UE device reduces a selection of CSI-RS resources for precoder selection by an indication in the MAC-CE or the DCI.

In some embodiments, the UE device receives a third control signaling indicating physical uplink shared channel (PUSCH) resource(s) or physical uplink control channel (PUCCH) resource(s). The UE device transmits the precoder to the first network entity using the indicated PUSCH resource(s) or PUCCH resource(s). In some cases, the third control signaling includes at least one of RRC, MAC CE, or DCI (e.g., and not limited to PDCCH).

In some embodiments, the one or more precoded SRS resources in the at least one SRS resource set includes SRS resources in an SRS resource set for NCB; or SRS resources in an SRS resource set for antenna switching (AS).

In some embodiments, transmitting the precoder report is based on: at least one spatial domain basis

$$( e . g . , {W}_{1} in {W}_{1} = [ \begin{matrix}B & 0 \\ 0 & B\end{matrix} ] ) ,$$

at least one coefficient indicating the spatial domain basis combining factor (e.g., Kc coefficients for W₂), and an index for the reported coefficient(s). In some cases, the control signaling includes a radio resource control (RRC) signaling configuring at least one of: a number of horizontal antenna ports, a number of horizontal oversampling factors, a number of vertical antenna ports, a number of vertical oversampling factors, a number of spatial bases, or the at least one coefficient associated with the strong signal.

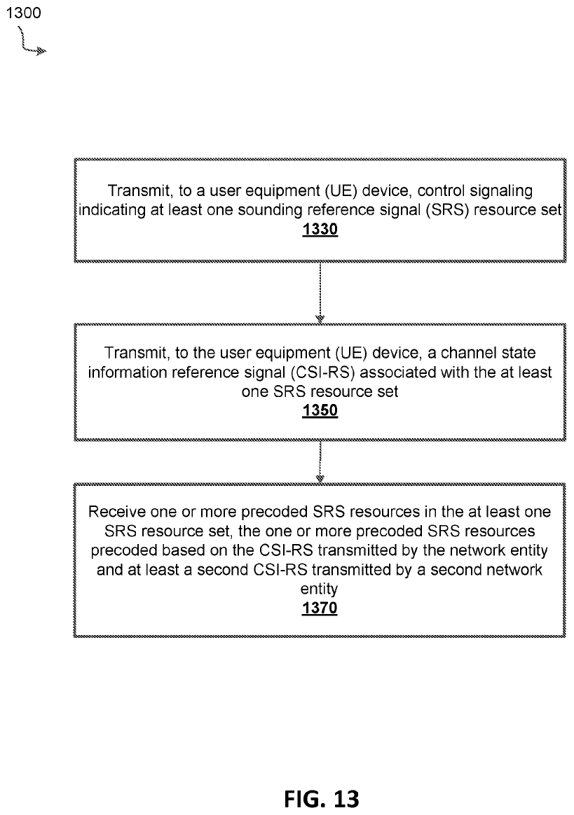

FIG. 13 is a flow diagram depicting a method of precoder determination by a network entity in multi-TRP applications, according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method of the flow diagram 1000 is performed by a UE device. The network entity may include one or more radio frequency (RF) modems, a processor coupled to the one or more RF modems, and at least one non-transient memory storing executable instructions to manipulate at least one of the processor or the RF modems to perform the method of the flow diagram 1000. A network entity may perform a complimentary method of the flow diagram 1000 to interact with the UE device performing the method (see call flow diagrams 400 and 700 in FIGS. 4 and 7A, for example, among others).

With reference to FIG. 13, the flow diagram 1300 illustrates example functions used by various embodiments. Although specific function blocks (“blocks”) are disclosed in the flow diagram 1300, such blocks are examples. That is, embodiments are well suited to performing various other blocks or variations of the blocks recited in method. It is appreciated that the blocks in method may be performed in an order different than presented, and that not all of the blocks in method may be performed.

As shown in FIG. 13, the network entity transmits 1320 to a UE device control signaling indicating at least one SRS resource set (similar to 430 of FIG. 4). The network entity transmits 1350 a CSI-RS associated with the at least one SRS resource set (similar to 1450 and 1455 of FIGS. 4, 752, 755, 754, and 757 of FIG. 7A, or 850 and 855 of FIG. 8A). The network entity receives 1370 one or more precoded SRS resources in the at least one SRS resource set. The one or more precoded SRS resources are precoded based on the CSI-RS(s) transmitted by the network entity and at least a second CSI-RS transmitted by a second network entity (e.g., a second target TRP in a multi-TRP scenario).

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “includes,” “including,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. For example, the dashed lines indicate optional operations herein. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

### EXAMPLES

### UE Examples

1. An apparatus, comprising a processer configured to cause a User Equipment (UE) to:
   receive the control signaling indicating at least one sounding reference signal (SRS) resource set associated with at least two Channel State Information Reference Signal (CSI-RS);
   receive the associated CSI-RS(s);
   determine the precoder based on the received associated CSI-RSs;
   transmit the SRS resource(s) in the SRS resource set based on the determined precoder.
2. The apparatus according to example 1, wherein the SRS is the SRS used for uplink non-codebook (NCB) based transmission.
3. The apparatus according to example 1, wherein the SRS is the SRS used for antenna switching (AS).
4. The apparatus according to example 1, wherein the UE further transmits the UE capability for SRS with at least one associated channel state information reference signal (CSI-RS) includes at least one of elements: the maximum number of associated CSI-RS resources for signal reception for an SRS resource set for NCB, the maximum number of associated CSI-RS resources for interference suppression for an SRS resource set for NCB; whether the UE supports associated CSI-RS resource for an SRS resource set for AS; the maximum number of associated CSI-RS resources for signal reception for an SRS resource set for AS; the maximum number of associated CSI-RS resources for interference suppression for an SRS resource set for AS.
5. The apparatus according to example 1, wherein the control signaling may include a first list of CSI-RS resource(s) for signal reception.
6. The apparatus according to example 1, wherein the control signaling may include a second list of CSI-RS resource(s) for interference suppression.
7. The apparatus according to example 1, 5 and 6, wherein for the control signaling may be an RRC signaling.
8. The apparatus according to example 7, wherein further down-selection for the CSI-RS resources for precoder selection may be indicated by MAC control element (CE).
9. The apparatus according to example 7, wherein further down-selection for the CSI-RS resources for precoder selection may be indicated by Downlink Control Information (DCI).
10. The apparatus according to example 1, wherein the associated CSI-RSs and the SRS resource set may be jointly triggered by a DCI field or MAC CE.
11. The apparatus according to example 1, wherein the UE determines the precoder based on the associated CSI-RS(s) for signal reception and associated CSI-RS(s) for interference suppression.
12. The apparatus according to example 11, wherein the UE transmits the precoder by PUCCH or PUSCH.
13. The apparatus according to example 12, wherein the PUCCH or PUSCH resource is configured by RRC signaling.
14. The apparatus according to example 12, wherein the PUCCH or PUSCH resource is configured by MAC CE.
15. The apparatus according to example 12, wherein the PUCCH or PUSCH resource is indicated by DCI.
16. The apparatus according to example 12, wherein the UE reports the precoder based on the quantized amplitude and phase for each coefficient.
17. The apparatus according to example 16, wherein the number of bits for amplitude quantization is configured by RRC signaling.
18. The apparatus according to example 16, wherein the number of bits for phase quantization is configured by RRC signaling.
19. The apparatus according to example 12, wherein the UE reports the precoder based on the at least one spatial domain basis, at least one strongest coefficient and the index for the reported coefficient(s).
20. The apparatus according to example 19, wherein at least one of the parameters: the number of horizontal antenna ports, number of horizontal oversampling factor, number of vertical antenna ports, number of vertical oversampling factor and number of spatial bases are configured by RRC signaling.
21. The apparatus according to example 19, wherein the number of reported strongest coefficients is configured by RRC signaling.

### BS Examples

1. An apparatus, comprising a processer configured to cause a Base Station (BS) to:
   transmit the control signaling with at least one Sounding Reference Signal (SRS) resource set associated with at least two channel state information reference signals (CSI-RS);
   transmit the associated CSI-RS(s);
   receive the precoded SRS resources in the at least one SRS resource set.
2. The apparatus according to example 1, wherein the SRS is the SRS used for uplink non-codebook (NCB) based transmission.
3. The apparatus according to example 1, wherein the SRS is the SRS used for antenna switching (AS).
4. The apparatus according to example 1, wherein the BS further receives the UE capability includes at least one of elements: the maximum number of associated CSI-RS resources for signal reception for an SRS resource set for NCB, the maximum number of associated CSI-RS resources for interference suppression for an SRS resource set for NCB; whether the UE supports associated CSI-RS resource for an SRS resource set for AS; the maximum number of associated CSI-RS resources for signal reception for an SRS resource set for AS; the maximum number of associated CSI-RS resources for interference suppression for an SRS resource set for AS.
5. The apparatus according to example 1, wherein the control signaling may include a first list of CSI-RS resource(s) for signal reception.
6. The apparatus according to example 1, wherein the control signaling may include a second list of CSI-RS resource(s) for interference suppression.
7. The apparatus according to example 1, 5 and 6, wherein for the control signaling may be an RRC signaling.
8. The apparatus according to example 7, wherein further down-selection for the CSI-RS resources for precoder selection may be indicated by MAC control element (CE).
9. The apparatus according to example 7, wherein further down-selection for the CSI-RS resources for precoder selection may be indicated by Downlink Control Information (DCI).
10. The apparatus according to example 1, wherein the associated CSI-RSs and the SRS resource set may be jointly triggered by a DCI field or MAC CE.
11. The apparatus according to example 1, wherein the BS further receives the precoder applied for the most recent SRS by PUCCH or PUSCH.
12. The apparatus according to example 12, wherein the PUCCH or PUSCH resource is configured by RRC signaling.
13. The apparatus according to example 12, wherein the PUCCH or PUSCH resource is configured by MAC CE.
14. The apparatus according to example 12, wherein the PUCCH or PUSCH resource is indicated by DCI.
15. The apparatus according to example 11, wherein the precoder is reported based on the quantized amplitude and phase for each coefficient.
16. The apparatus according to example 15, wherein the number of bits for amplitude quantization is configured by RRC signaling.
17. The apparatus according to example 15, wherein the number of bits for phase quantization is configured by RRC signaling.
18. The apparatus according to example 11, wherein the precoder is reported based on the at least one spatial domain basis, at least one strongest coefficient and the index for the reported coefficient(s).
19. The apparatus according to example 18, wherein at least one of the parameters: the number of horizontal antenna ports, number of horizontal oversampling factor, number of vertical antenna ports, number of vertical oversampling factor and number of spatial bases are configured by RRC signaling.
20. The apparatus according to example 18, wherein the number of reported strongest coefficients is configured by RRC signaling.

1-20. (canceled)

21. A method of precoder determination by a user equipment (UE), the method comprising:
receiving, from a first network entity, a first channel state information reference signal (CSI-RS);
receiving, from a second network entity, a second CSI-RS;
receiving, from the first network entity, a first control signaling indicating at least one sounding reference signal (SRS) resource set associated with at least the first CSI-RS or the second CSI-RS for non-codebook (NCB) based uplink transmission; and
transmitting, to the first network entity, one or more SRSs in the at least one SRS resource set using a precoder computed based on at least the first CSI-RS and the second CSI-RS.

22. The method of claim 21, further comprising:
receiving, from a third network entity, a third CSI-RS; and
determining, at the UE, the precoder for transmitting the one or more SRSs based on at least the first CSI-RS, the second CSI-RS, and the third CSI-RS such that the precoded SRS resources suppress interference to signals received at the third network entity.

23. The method of claim 21, further comprising:
receiving, from the first network entity, a second control signaling for triggering the transmitting the one or more SRSs, wherein the second control signaling is associated with at least the first CSI-RS or the second CSI-RS, wherein the second control signaling includes an SRS request field in downlink control information (DCI).

24. The method of claim 21, further comprising:
transmitting, to the first network entity, an indication that the UE is capable of uplink precoder selection for SRS associated with more than one CSI-RSs, wherein the indication comprises at least one of:
a maximum number of associated CSI-RS resources for signal reception for an SRS resource set for non-codebook (NCB);
a maximum number of associated CSI-RS resources for interference suppression for an SRS resource set for NCB;
that the UE supports an associated CSI-RS resource for an SRS resource set for antenna switching (AS);
a maximum number of associated CSI-RS resources for signal reception for an SRS resource set for AS; or
a maximum number of associated CSI-RS resources for interference suppression for an SRS resource set for AS.

25. The method of claim 21, wherein the first control signaling comprises at least one of:
a first list of CSI-RS resources associated with signal reception at the UE, the first list of CSI-RS comprising at least the first CSI-RS or the second CSI-RS; or
a second list of CSI-RS resources associated with interference suppression caused by signal transmissions at the UE, the second list of CSI-RS comprising at least a third CSI-RS from a victim network entity.

26. The method of claim 21, wherein the first control signaling comprises a radio resource control (RRC) signaling, and the method further comprising at least one of:
receiving a media access control-control element (MAC-CE) for activating a semi-persistent SRS and associated semi-persistent CSI-RSs; or
receiving a downlink control information (DCI) to trigger aperiodic SRS and associated aperiodic CSI-RSs.

27. The method of claim 26, further comprising:
jointly triggering, by the MAC-CE or the DCI, the SRS resource set and the associated first CSI-RS, the second CSI-RS, or both.

28. The method of claim 27, further comprising:
receiving a third control signaling indicating a physical uplink shared channel (PUSCH) resource or a physical uplink control channel (PUCCH) resource; and
transmitting a precoder report to the first network entity using the indicated PUSCH resource or PUCCH resource.

29. The method of claim 28, wherein the transmitting the precoder report is based on:
a quantized amplitude and a quantized phase for each precoding weight coefficient, as configured by the RRC signaling.

30. The method of claim 28 wherein transmitting the precoder report is based on:
at least one spatial domain basis,
at least one coefficient indicating the spatial domain basis combining factor, and
an index for the at least one coefficient.

31. The method of claim 30, wherein the RRC signaling configures at least one of:
a number of horizontal antenna ports,
a number of horizontal oversampling factors,
a number of vertical antenna ports,
a number of vertical oversampling factors,
a number of spatial bases, or
the number of coefficient(s) indicating the spatial domain basis combining factor.

32. The method of claim 21, wherein transmitting the one or more SRSs in the at least one SRS resource set comprises:
transmitting one or more SRS resources in an SRS resource set for NCB; or
transmitting one or more SRS resources in an SRS resource set for antenna switching (AS).

33. A method of precoder determination by a first network entity, the method comprising:
transmitting, to a user equipment (UE), a first control signaling indicating a sounding reference signal (SRS) resource set associated with a channel state information reference signal (CSI-RS);
transmitting, to the UE, a first channel state information reference signal (CSI-RS) associated with the SRS resource set for non-codebook (NCB) based uplink transmission; and
receiving one or more SRSs in the SRS resource set, the one or more SRSs precoded based on the first CSI-RS and at least a second CSI-RS transmitted by a second network entity.

34. The method of claim 33, further comprising:
transmitting, to the UE, a third CSI-RS;
receiving the one or more SRSs determined based on at least the first CSI-RS, the second CSI-RS, and the third CSI-RS such that the one or more SRSs suppress interference to signals received at a third network entity associated with the third CSI-RS, wherein receiving the one or more SRSs comprises:
receiving one or more SRSs in an SRS resource set for NCB; or
receiving one or more SRSs in an SRS resource set for antenna switching (AS); and
transmitting, to the UE, a second control signaling for triggering transmission of the one or more precoded SRSs, wherein the second control signaling is associated with the first CSI-RS or the second CSI-RS, and wherein the second control signaling includes an SRS request field in downlink control information (DCI).

35. The method of claim 33, further comprising:
receiving, from the UE, an indication that the UE is capable of uplink precoder selection for SRS associated with CSI-RSs from two or more network entities, wherein the indication comprises receiving at least one of:
a maximum number of associated CSI-RS resources for signal reception for an SRS resource set for non-codebook (NCB);
a maximum number of associated CSI-RS resources for interference suppression for an SRS resource set for NCB;
that the UE supports associated CSI-RS resource for an SRS resource set for antenna switching (AS);
a maximum number of associated CSI-RS resources for signal reception for an SRS resource set for AS; or
a maximum number of associated CSI-RS resources for interference suppression for an SRS resource set for AS.

36. The method of claim 33, wherein the first control signaling comprises at least one of:
a first list of CSI-RS resources associated with signal reception at the UE, the first list of CSI-RS comprising at least the first CSI-RS or the second CSI-RS; or
a second list of CSI-RS resources associated with interference suppression caused by signal transmissions at the UE, the second list of CSI-RS comprising at least a third CSI-RS from a victim network entity.

37. The method of claim 34, wherein:
the first control signaling comprises a radio resource control (RRC) signaling; and
the second control signaling comprises a media access control-control element (MAC-CE) for activating a semi-persistent SRS and associated semi-persistent CSI-RSs or a downlink control information (DCI) to trigger aperiodic SRS and associated aperiodic CSI-RSs.

38. The method of claim 37, further comprising:
jointly triggering, by the MAC-CE or the DCI, the SRS resource set and the associated first CSI-RS, the second CSI-RS, or both.

39. The method of claim 37, further comprising:
transmitting, to the UE, a third control signaling indicating a physical uplink shared channel (PUSCH) resource or a physical uplink control channel (PUCCH) resource; and
receiving a precoder report from the UE in the indicated PUSCH resource or PUCCH resource, wherein receiving the precoder report is based on:
transmitting, to the UE, a radio resource control (RRC) message to configure a quantized amplitude and a quantized phase for each precoding weight coefficient for the precoder report.

40. A user equipment (UE), comprising:
one or more radio frequency (RF) modems;
a processor coupled to the one or more RF modems; and
at least one memory storing executable instructions, the executable instructions to manipulate at least one of the processor or the one or more RF modems to:
receive, from a first network entity, a first channel state information reference signal (CSI-RS)
receive, from a second network entity, a second CSI-RS;
receive, from the first network entity, a first control signaling indicating a sounding reference signal (SRS) resource set associated with at least the first CSI-RS or the second CSI-RS for non-codebook (NCB) based uplink transmission; and
transmit, to the first network entity, one or more SRSs in the SRS resource set using a precoder computed based on at least the first CSI-RS and the second CSI-RS.
